(19) United States
(12) Patent Application Publication
(10) Pub. No.: US 2003/0220459 A1
(43) Pub. Date: Nov. 27, 2003

(54) Heat-sensitive water soluble copolymers based on(poly)ethoxylated(meth) acrylate, method for making same and use for preparing adhesive films and binders for textiles webs

(76) Inventor: Denis Tembou N'Zudie, Vienne (FR)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 10/311,862

(22) PCT Filed: Jun. 26, 2001
(86) PCT No.: PCT/FR01/02015

(30) Foreign Application Priority Data
Jun. 27, 2000 (FR) 00/08229

(51) Int. Cl. C08F 128/02; C08F 228/02

(52) U.S. Cl. 526/287

(57) ABSTRACT

The heat-sensitive water-soluble copolymer is obtained from a composition of water-soluble monomers comprising, for 100 molar parts (pp): from 10 to 69 pp of at least one compound (I) and/or (II); from 30 to 75 pp of at least one ethylenically unsaturated sulphonic acid; from 0 to 50 pp of at least one compound (III) and/or (IV); from 0 to 30 pp of at least one compound (V) and/or (VI); from 0 to 30 pp of at least one other monomer such as (VII) and/or (VIII) and/or (IX) and/or acrylonitrile and/or allyl alcohol and/or vinylpyridine and/or an unsaturated monomer which is a carboxylic acid or an anhydride of a carboxylic acid and/or a silane monomer and/or a phosphate-function monomer and/or a phosphonated monomer and/or a monomer having N-vinyl groups; and from 0.001 to 50 pp of at least one hydrophobic monomer.

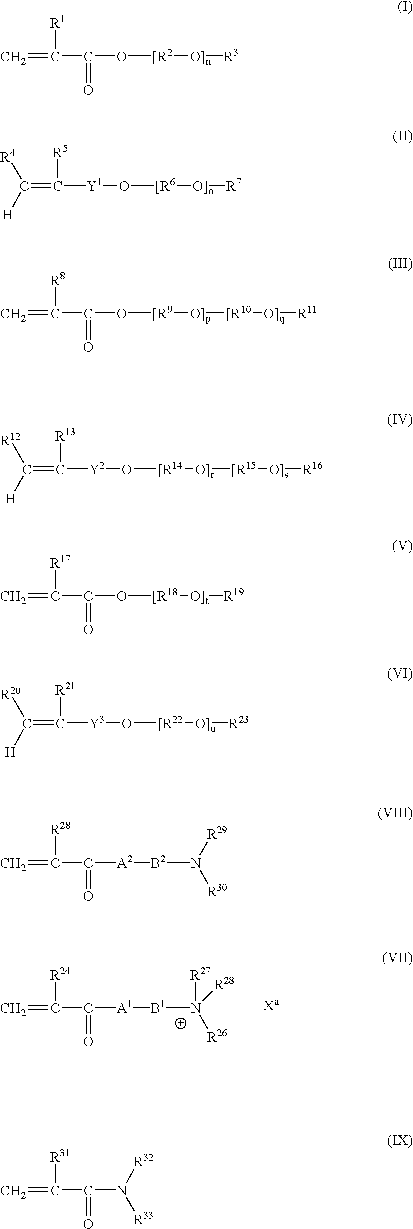

R¹, R³, R⁷, R⁸, R¹¹, R¹⁶, R¹⁷, R²⁴, R²⁸, R³¹=H, —CH₃; R², R⁶=—CH₂—CH₂ which may bear at least one OH or C₃-C₄ alkylene radical bearing at least one OH radical; and R⁹, R¹⁰, R¹⁴, R¹⁵, R¹⁸, R²²=C₂-C₄ alkylene which may bear at least one OH radical, n, o, p, r, t, u=from 1 to 70; q, s=from 1 to 40 ;R⁴, R⁵, R¹², R¹³, R²⁰, R²¹=H, C₂-C₄ alkyl; Y¹, Y², Y³=single bond, C₁-C₄ alkylene; R¹⁹, R²³=C₂-C₄₀ alkyl radical, C₆-C₆₀ aralkyl radical or aryl radical, A¹, A²=O, NH; B¹, B³=—CH₂CH₂—, —CH₂CH₂CH₂—, —CH₂CHOHCH₂—; R²⁵, R²⁶, R²⁹, R³⁰=CH₅, C₂-C₁₆ alkyl radical; R₂₇=H, CH₃, C₂-C₁₆ alkyl radical; X⁶=monovalent anion; R³³, R³³=H, C₁-C₅ alkyl radical, (C₁-C₅ alkoxy)-C₁-C₅ alkyl radical.

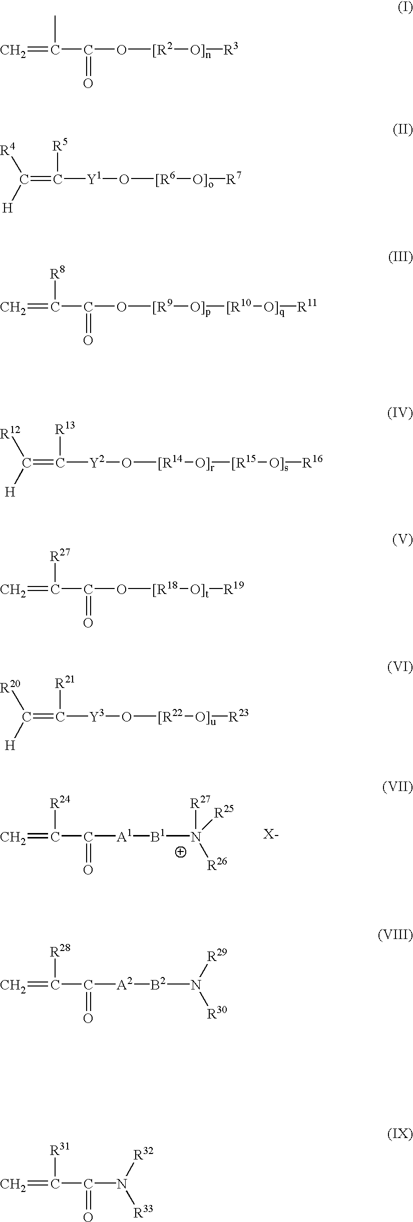

The present invention relates to heat-sensitive water-soluble copolymers based on (poly)ethoxylated (meth)acrylate, their manufacture and their use for the production of films, adhesives and binders for fibrous sheets, particularly for the manufacture of water-disintegrable hygiene items.

The present invention particularly relates to heat-sensitive water-soluble copolymers which can be used for the manufacture of hygiene items capable of disposal in toilets because they can form films capable of rapid disintegration or break-up when agitated in an aqueous medium Other uses of the copolymers of the invention as components of disposable or water-disintegrable hygiene items are:

(1) as binder connecting the fibres of the fibrous sheets (nonwovens) which form the overwrap of the item; or

(2) for formulating adhesives whose function is to connect the various constituents of the item, a particular example being adhesives for connecting the overwrap and underwrap between which the absorbent material is encapsulated; or

(3) as a component of a compounded material of the polymer forming the underwrap generally based on polyolefin.

More specifically, water-soluble copolymers which are heat-sensitive or have heat-sensitive character are copolymers which are soluble in water below a certain critical temperature commonly termed LCST, but which become insoluble in water at temperatures above the LCST. Thus, for example, films produced from these copolymers may be called “water-disintegrable” or “water-dispersible”.

In the particular application in hygiene items, the said copolymers must be readily dispersible when agitated in water (from 5 to 20° C.) so as to be capable of flush-disposal without blocking the pipes, but at the temperature of the human body (37° C.) they must be insoluble in water and in body fluids in order to ensure the integrity of these items during their use. In other words, for this application the composition of the polymers must be capable of being adjusted in such a way that their LCST is below the temperature of the human body (37° C.) while being above the temperature of the water in toilets (from 5 to 20° C.) in order to ensure insolubility in water at 37° C. together with good dispersibility or solubility in water at from 5 to 20° C.

The manufacturers of disposable items such as babies' nappies, incontinence garments, and feminine hygiene products have for many years been subjected to powerful pressure in relation to the problem posed by the disposal of these products. Although significant progress has been made in controlling these problems one of the weak links is the inability to manufacture items which would readily disintegrate in water while having good mechanical strength in contact with body fluids. Reference may be made to the British Patent Application GB-A-2 241 372 and to the American Patent U.S. Pat. No. 4,186,233. Otherwise it becomes much less possible, or even impossible, for the user to discard these products in toilets. Furthermore, the ability of the product to disintegrate in waste is strictly limited because many of the components which are present in the product and which may be biodegradable or photodegradable are encapsulated in the plastic material which takes a long time to degrade following splitting of the encapsulation in the plastic material.

The PCT International Applications WO/96 20831 and WO/97 18082 describe the compositions of plastic films capable of disintegration in the presence of water. In contrast to films, the person skilled in the art is also seeking to perfect fibrous or nonwoven sheets (International Applications WO/98 36117 and WO/98 29590, French Patent Application FR-A-2 709 055) having the ability to disintegrate in water. One of the approaches here consists in formulating the binder whose function is to connect the fibres of the nonwoven in such a way that it brings about the disintegration of the fibrous sheet in an aqueous medium. Water-dispersible adhesives connecting the various components of the hygiene item are moreover proposed in the American Patents U.S. Pat. No. 4,522,967 and U.S. Pat. No. 5,527,845.

The various types of water-dispersible polymers proposed for the manufacture of the films, fibres, binders for fibrous sheets and adhesives are described in the British Patent Application GB-A-2 284 820. Five types of products emerge from that document:

(1) pH-sensitive products with the disadvantage that it is necessary to add an ingredient (acid or base) or pre-wet the item prior to disposal;

(2) products sensitive to enzymes, which have disadvantages comparable with the above products;

(3) products sensitive to ionic forces, i.e. insoluble in a saline aqueous medium and soluble in a non-saline aqueous medium or weakly saline aqueous medium;

(4) products sensitive to temperature (heat-sensitive) having a large difference in solubility at the critical temperature LCST and in particular a significant solubility disparity between the temperature of the human body 37° C. and that of the water in toilets, from 5 to 20° C.; and

(5) the above hydrophilic products formulated with hydrophobic substances which give the item more mechanical strength when it is moist (in contact with body fluids).

Among the heat-sensitive products claimed in the literature for this application, particular mention may be made of:

(1) hydroxypropylcellulose (LCST=44° C.) and methylated hydroxypropylcellulose, in which the hydrophobic modification by methylation of the hydroxypropylcellulose permits the LCST to be reduced to the range of from 19 to 35° C. (American Patent U.S. Pat. No. 5,770,528);

(2) polyvinyl methyl ether (PVME) having an LCST of 35° C. (PCT International Application WO/98 29157);

(3) poly-N-isopropylacrylamide (polyNIPAM) having an LCST of 35° C. (PCT International Application WO/97 24150).

For application in hygiene products, the person skilled in the art is seeking compositions of heat-sensitive copolymers having LCSTs of between 20 and 60° C., preferably between 20 and 35° C., with preference between 23 and 28° C., and preferably about 24° C. In the light of the affinity of these products for water, the person skilled in the art is also seeking to mix these heat-sensitive polymers with hydrophobic polymers to improve wet strength, but compatibility problems can arise between the two (heat-sensitive and hydrophobic) polymers.

The present invention proposes novel compositions of heat-sensitive copolymers meeting these criteria and permitting access to a wide LCST range capable of variation between 6 and 95° C., in particular the range from 20 to 35° C., for the particular application envisaged. The adjustment of the LCST within this temperature range is possible by varying parameters such as the transfer agent, the nature and the proportion of the monomers used for the copolymerization, the synthesis temperature, the manner of introduction of the monomers (batchwise or semicontinuous), the molar masses of the copolymers. In addition, low LCST values (from about 20 to 24° C.) can be obtained by varying the number of alkylene oxide units present, the composition and the transfer agent, and the adjustment of the LCST to low temperatures (from 20 to 24° C.) permits a rapid soluble/insoluble kinetic transition to be obtained at skin temperature (37° C.), unlike with systems whose LCST is higher (PVME and polyNIPAM).

In addition, to mitigate the problem of incompatibility related to the mixture with the hydrophobic polymers, the hydrophobic units are directly incorporated within the structure of the novel heat-sensitive water-soluble copolymers of the present invention.

These novel heat-sensitive polymers permit production of water-dispersible films. They may also be used with hydrophobic polymers in proportions which maintain the water-disintegrability of the films of the formulated product. They may also be used for the formulation of binders for fibrous sheets, and for water-dispersible adhesives for the manufacture of water-disintegrable hygiene items.

The present invention therefore provides a heat-sensitive water-soluble copolymer, characterized in that it is obtained from a composition of monomers comprising, for 100 molar parts:

(A) from 10 to 69 molar parts of at least one water-soluble compound chosen from those of the formulae (I) and (II) below:

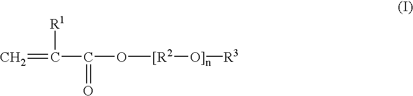

where:

R¹ represents H or —CH₃;

R² represents a C₂ alkylene radical which optionally contains one or more OH groups, or a C₃-C₄ alkylene radical which contains one or more OH groups;

R³ represents H or —CH₃; and

n is a whole number between 1 and 70;

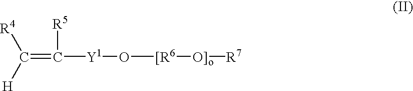

where:

each of R⁴ and R⁵ independently represents hydrogen or C₂-C₄ alkyl;

Y¹ is a single bond or a C₂-C₄ alkylene radical;

R⁶ represents a C₂ alkylene radical which optionally contains one or more OH groups, or a C₃-C₄ alkylene radical which contains one or more OH groups;

R⁷ represents H or —CH₃; and

o is a whole number between 1 and 70;

(B) from 30 to 75 molar parts of at least one water-soluble monomer chosen from the ethylenically unsaturated sulphonic acids;

(C) from 0 to 50 molar parts of at least one water-soluble compound selected from those of the formulae (III) and (IV):

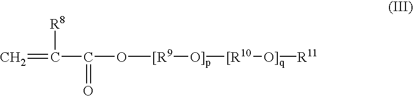

where:

R⁸ represents H or —CH₃;

each of R⁹ and R¹⁰ independently represents a C₂-C₄ alkylene radical which optionally contains one or more OH groups, where each of R⁹ and R⁴⁰ differs from the other;

R¹¹ represents H or —CH₃;

p is a whole number between 1 and 70; and

q is a whole number between 1 and 40;

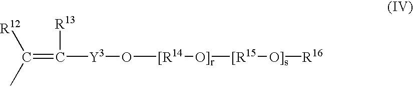

H

where:

each off R¹² and R¹³ independently represents hydrogen or C₂-C₄ alkyl;

Y² is a single band or a C₁-C₄ alkylene radical;

each of R¹⁴ and R¹⁵ independently represents a C₂-C₄ alkylene radical optionally containing one or more OH groups, where each of R¹⁴ and R¹⁵ differs from the other;

R¹⁶ represents H or —CH₅;

r is a whole number between 1 and 70; and

s is a whole number between 1 and 40;

(D) from 0 to 30 molar parts of at least one water-soluble compound chosen from chose of formulae (V) and (VI):

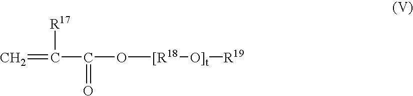

where:

R¹⁷ represents H or —CU₃;

R¹⁸ represents a C₃-C₄ alkylene radical which optionally contains one or more OH groups (where in particular the C₃-C₄ compounds contain at least one OH group to ensure their solubility in water);

R¹⁹ represents a C₃-C₄ alkyl chain, or a C₆-C₆₀ aralkyl or aryl chain; and

t is a whole number between 1 and 70;

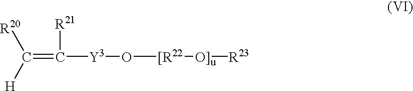

where:

each of R²⁰ and R²¹ independently represents hydrogen or C₂-C₄ alkyl;

Y³ is a single bond or a C₁-C₄ alkylene radical;

R²² represents a C₂-C₄ alkylene radical which optionally contains one or more OH groups (where in particular the C₃-C₄ compounds contain at least one OH group to ensure their solubility in water);

R²³ is a C₂-C₄₀ alkyl radical or a C₆-C₆₀ aralkyl or aryl radical; and

u is a whole number between 1 and 70;

(E) from 0 to 30 molar parts of at least one water-soluble monomer chosen from:

(E1) water-soluble compounds of formula (VII):

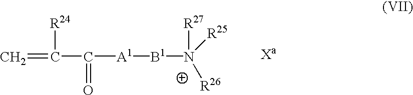

where:

R²⁴ represents H or —CH₃;

A¹ represents —O— or —NH—;

B¹ represents —CH₂CH₂—, —CH₂CH₂CH₂— or —CH₂CHOHCH₂—;

each of R²⁵ and R²⁶ independently represents —CH₃ or a C₃-C₁₆ alkyl chain;

R²⁷ represents H, —CH₃ or a C₃-C₁₆ alkyl chain;

X^{a} represents a monovalent anion, such as Cl^{a}, SCN^{a},CH₃SO₃^{a} or Br^{a};

(E2) water-soluble compounds of formula (VIII):

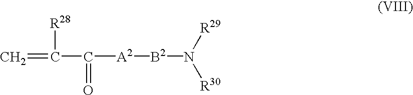

where:

A² represents —O— or —NH—;

B² represents —CH₂CH₂— —CH₂CH₂CH₃— or —CH₂CHOHCH₂—;

R²⁸ represents H or —CH₃; and

each of R²⁹ and R³⁰ independently represents —CH₃ or a C₂-C₁₆ alkyl chain;

(E3) water-soluble monomers chosen from the ethylenically unsaturated carboxylic acids and their salts and the anhydrides of ethylenically unsaturated carboxylic acids;

(E4) water-soluble ethylenically unsaturated silane monomers;

(E5) water-soluble ethylenically unsaturated phosphate-function monomers;

(E6) water-soluble ethylenically unsaturated phosphonate monomers and their salts;

(E7 ) water-soluble monomers having N-vinyl groups;

(E8) water-soluble compounds of formula (IX):

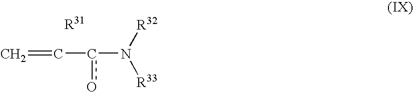

where:

R³¹ represents H or —CH₃;

R³² and R³³ are identical or different, each independently representing H, C₁-C₅ alkyl which optionally contains one or more OH groups, or (C₁-C₅ alkoxy)-C₁-C₅ alkyl;

(E9) acrylonitrile;

(E10) allyl alcohol;

(E11) vinylpyridine;

(E12) N-(meth)acryloyltris(hydroxymethyl)-methylamine; and

(E13) 2-(acetoacetoxy)ethyl (meth)acrylate; and

(F) from 0.001 to 50 molar parts of at least one hydrophobic monomer,

the said heat-sensitive water-soluble copolymer having an LCST of from 60° C. to 95° C.

The preferred monomer(s) (A) of formula (I) are in particular chosen from the compounds of formula (Ia):

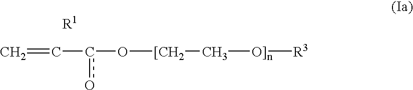

where R¹, R³ and n are as defined above.

The preferred monomer(s) (A) of formula (II) are in particular chosen from the compounds of formula (IIa) or (IIb):

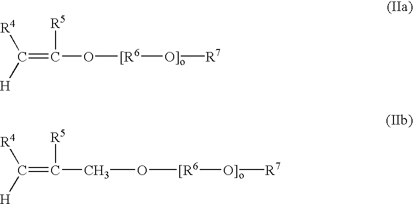

where R⁴ to R⁷ and o are as defined above.

The monomer (B) is in particular 2-acrylamido-2-methylpropanesulphonic acid (AMPS).

The preferred monomer(s) (C) of formula (III) are in particular chosen from the compounds of formula (IIIa) or (IIIb):

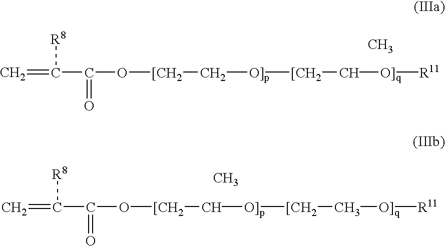

where R⁸, R¹¹, p and q are as defined above.

Examples of the monomer(s) (D) of formulae (V) and (VI) are those where R¹⁸ and R²² represent —CH₂—CH₂—.

The compound(s) (E1) of formula (VII) are in particular chosen from the (meth)acryloyloxyethyltrimethyl-ammonium halides (such as the chlorides). Mention may in particular be made of acryloyloxyethyltrimethylammonium chloride.

The compound(s) (E2) of formula (VIII) are in particular chosen from dimethylaminoethyl acrylate and dimethylaminoethyl methacrylate.

Examples of the compound(s) (E3) are methacrylic acid and its salts.

The compound(s) (E4) are chosen from (meth)acryloxyalkylsilanes, for example.

The monomer(s) (E6) are chosen in particular from allylphosphonic acid and its salts.

The compound(s) (E7) are in particular chosen from N-vinylacetamide, N-vinylpyrrolidone, N-vinylimidazole and N-vinylcaprolactam.

The compound(s) (E8) are in particular chosen from acrylamide, methacrylamide, N-isopropylacrylamide, N-ethoxy-propylacrylamide, N-methylol(meth)acrylamide, N,N-dimethylacrylamide and N-(2-hydroxypropyl)(meth)acrylamide.

The hydrophobic monomer(s) (F) are in particular chosen from:

(F1) the monomers of formula (X):

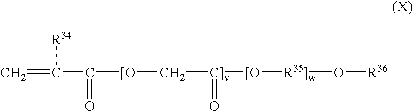

where:

R³⁴ represents H or —CH₃;

v is 0 or 1;

R³⁵ represents a C₁-C₆ alkylene radical;

w is 0 or is a whole number between 1 and 10; and

R³⁶ represents a C₁-C₃₂ alkyl radical or a cycloalkyl radical;

(F2) the monomers or formula (X):

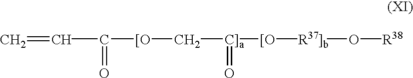

where:

a is 0 or 1;

R³⁷ represents a C₁-C₆ alkylene radical or a halogenated C₁-C₆ alkylene radical;

b is 0 or is a whole number between 1 and 10;

R³⁸ represents a C₁-C₂₀ alkyl radical, a cycloalkyl radical, a halogenated alkyl radical or a halogenated cycloalkyl radical,

with the proviso that if b is 0 R³⁸ is a halogenated C₁-C₁₆ alkyl radical or a halogenated cycloalkyl radical;

(F3) the hydrophobic vinyl monomers of formula (XII):

CH₂═CH—R³⁹

where R³⁹ is an alkyl carboxylate group or alkyl ether group containing from 1 to 18 carbon atoms, an aryl or aralkyl group or a cycloalkyl group;

(F4) the monomers of formula (XIII):

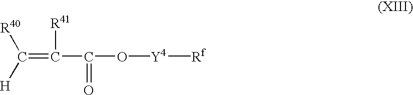

where:

one of R⁴⁰ and R⁴¹ represents a hydrogen atom and the other represents a hydrogen atom or an alkyl radical containing from 1 to 4 carbon atoms;

Y⁴ represents a bivalent hydrocarbon chain bonded to O by a carbon atom and may contain one or more heteroatoms chosen from oxygen, sulphur and nitrogen; and

R^{f} represents a perfluorinated straight-chain or branched radical containing from 2 to 20 carbon atoms, preferably from 4 to 16 carbon atoms;

(F5) monomers chosen from vinyl chloride and fluoride and vinylidene chloride and fluoride;

(F6) the hydrophobic monomers of formula (XIV):

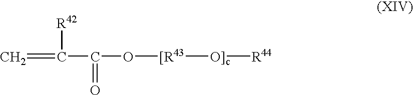

where:

R⁴² represents H or —CH₃;

R⁴³ represents a C₃-C₄ alkylene radical;

c is a whole number between 1 and 70; and

R⁴⁴ represents H or —CH₃;

(F7) the hydrophobic monomers of formula (XV):

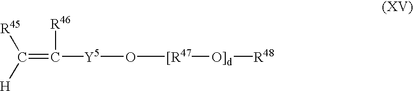

where:

each of R⁴⁵ and R⁴⁶ independently represents hydrogen or C₃-C₄ alkyl;

Y⁵ is a single bond or a C₁-C₄ alkylene radical;

R⁴⁷ represents a C₃-C₄ alkylene radical;

d is a whole number between 1 and 70; and

R⁴⁸ represents H or —C₃;

(F8) the fluorostyrenes;

(F9) the compounds of formula (XVI):

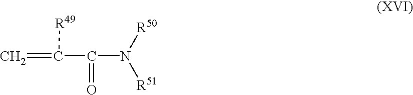

where:

R⁴⁹ represents H or —CH₃;

R⁵⁰ and R⁵¹ are identical or different, each independently representing a C₆-C₂₄ alkyl radical or a cycloalkyl radical; and

(F10) the n-alkyltriethoxysilane compounds and the n-alkyl-trimethoxysilane compounds having C₆-C₁₈ alkyl groups.

Examples of the compounds of formula (XIV) are chosen from those compounds containing an R⁴³ which is a

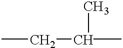

or —CH₂—CH₂—CH₃—CH₂ radical.

Examples of the compounds of formula (XV) are chosen from those compounds having an R⁴⁷ which is a

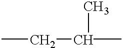

or —CH₂—CH₂—CH₂—CH₃ radical and having a Y⁵ which is a single bond or —CH₂—.

Examples of the compounds of formula (XVI) are chosen from N-(tert-butyl)((meth)acrylamide, N-decyl(meth)acrylamide, N-dodecyl(meth)acrylamide and N-(n-octadecyl)(meth)acrylamide.

The compound (F10) is in particular n-octradecyl-triethoxysilane.

The heat-sensitive water-soluble copolymer of the invention may moreover be obtained from a composition of monomers such as the composition defined above incorporating at least one chain-transfer agent in particular chosen from mercaptoethanol, isopropanol, alkyl mercaptans, such as methyl mercaptan, ethyl mercaptan, etc., carbon tetrachloride and triphenylmethane, the rate at which the transfer agent(s) was/were used being in particular from 0.05 to 8% by weight, based on the total weight of the monomers.

The LCST of the heat-sensitive water-soluble copolymer of the invention may in particular be from 20 to 35° C., preferably from 23 to 28° C., and with preference about 24° C. As indicated above, and as illustrated by the examples, the person skilled in the art will readily be able to control the LCST of the copolymers of the invention. The examples below in particular show that:

the LCSTs of the copolymers of the invention increase with the number of units of ethylene oxide in the polyethoxylated monomer used;

the LCSTs of the copolymers of the invention increase if the proportion of transfer agent is increased, i.e. it the molar masses are low;

the LCSTs of the copolymers of the invention vary between 6 and 95° C. with variation in these parameters: the number of units of ethylene oxide, the proportion of transfer agent, the ratio of the monomers (A) and (B), the presence of functional units, and the proportion of hydrophobic monomers;

the incorporation of hydrophobic units in the structure of the copolymers based on ethylenically unsaturated sulphonic acid (AMPS) and (poly)ethoxylated (meth)acrylate helps to make the copolymers heat-sensitive while reducing their level of hydrophilic properties;

an increase in the proportion of hydrophobic units decreases the LCST;

an increase in the ratio of sulphonic acid monomer/ethoxylated monomer decreases the LCST;

as well as providing specific properties for the final application, the functionalization can therefore also assist adjustment of the LCST of the copolymers;

an increase in the molar masses of the copolymer decreases the LCST.

The present invention also provides a process for manufacturing a copolymer as defined above, characterized in that the free-radical copolymerization of water-soluble monomers as defined above is conducted in an organic (alcohols or ketones, for example) or aqueous solvent medium or in an organic solvent/water mixture, preferably in an aqueous medium (aqueous dispersion or solution). In particular, the polymerization is carried out with a total concentration of the monomers of between 5 and 75% by weight, in particular between 15 and 50% by weight.

The hydrophobic units obtained by polymerizing the hydrophobic monomers with water-soluble monomers of the present invention must maintain the sensitivity to heat of the polymer and its solubility in water, however.

In the event that the polymerization is carried out in an organic solvent medium or in an organic solvent/water mixture, the solvents, for example the alcohols and the ketones, promote the incorporation of the hydrophobic monomers in the structure of the water-soluble polymer, but they pose known problems related to the use of organic solvents, in particular safety issues, and their removal by drying and distillation with consumption of energy, and the cycle time.

The preferred polymerization process of the invention is based on synthesis in an aqueous medium. Under these circumstances there are two problems to be solved:

(1) The problem of incorporation of hydrophobic monomers in an aqueous medium, due to insolubility in water. It is well known that the use of a surfactant solution can mitigate this problem. The micellar polymerization described in the document Macromolecules 1993, 26, 4521-4532 is an example of a process based on this principle. In the present instance, the monomers of polyethoxylated (meth)acrylate type have the function of a polymerizable surfactant, thus contributing to the incorporation of the hydrophobic units. In addition, polymerization at a temperature above the LCST of the polymer configures the process as a precipitation polymerization where polymerization in dispersion also promotes the incorporation of these hydrophobic monomers via diffusion into the hydrophobic particles swollen by monomers.

(2) The problem related to maintaining the water-soluble and at the same time heat-sensitive character of the polymer in the light of the presence of hydrophobic units in the structure of the macromolecule. An excessively large proportion of hydrophobic units would have the entirely undesirable result of giving polymers which are insoluble in water at all temperatures and which therefore lack any sensitivity to temperature, thus not achieving the desired objective.

This invention provides solutions for these problems and demonstrates that:

(1) starting from the compositions of the invention comprising a mixture of water-soluble monomers and hydrophobic monomers, the synthesis of polymers which are both water-soluble and temperature-sensitive is highly dependent on the type of hydrophobic monomers to be incorporated and in particular the extent of their hydrophobic properties;

(2) the LCSTs of these copolymers depend on the composition of the water-soluble or hydrophobic monomers;

(3) the LCSTs of these water-soluble copolymers having hydrophobic units can vary over a large range from 6 to 95° C. and more particularly within the range from 18 to 37° C. necessary for application in hygiene items capable of disposal in toilets;

(4) to mitigate the problem of incompatibility related to the mixture with the hydrophobic polymers, the hydrophobic units are directly incorporated within the structure of the novel heat-sensitive water-soluble copolymers of the present invention. The reason for this is that because of the affinity of the heat-sensitive polymers for water, the person skilled in the art seeks to mix the heat-sensitive polymers with hydrophobic polymers to improve wet strength, but compatibility problems can arise between the two (heat-sensitive and hydrophobic) polymers).

The copolymerization of the invention is carried out in the presence of at least one free-radical-generator initiator, in particular chosen from the persulphates, such as ammonium persulphate and potassium persulphate, the peroxides and the diazo compounds, such as 2,2′-azobis(2-aminopropane) hydrochloride, the rate at which the free-radical-generator initiator(s) is/are used being in particular from 0.1 to 15% by weight, particularly from 0.5 to 3% by weight, based (on the total weight of the monomers involved. It is also possible to initiate the copolymerization by irradiation, for example in the presence of UV radiation and of phototinitiators such as benzo-phenone, 2-methylanthraquinone or 2-chlorothioxanthone.

If desired, the length of the polymeric chains may be controlled with the aid of chain-transfer agents such as those indicated above, used in proportions as indicated above.

The reaction temperature may vary within wide limits, i.e. from −40° C. to 200° C., operations preferably being carried out at from 50 to 95° C.

As indicated above, it is possible to adjust the LCST of the desired copolymer as a function of the composition of the monomers and/or of the amount of the chain-transfer agent used and/or of the temperature and/or of the batchwise or semicontinuous conduct of the process. The present description indicates to the person skilled in the art the elements which can be used as a basis for very easy implementation of this type of adjustment.

The present invention also provides a mixture of at least one heat-sensitive water-soluble copolymer as defined above or prepared by the process as defined above with at least one hydrophobic (co)polymer, such as poly(methyl methacrylate) or polyolefins. The copolymers of the invention may thus be formulated with hydrophobic polymers while maintaining the water-disintegrable character of the product (film).

The invention also provides the use of a copolymer as defined above or prepared by a process as defined above, or of a mixture as defined above comprising at most 50% by weight of hydrophobic (co)polymer(s), based on all of the polymers, for manufacturing water-dispersible or water-disintegrable films, in particular as a constituent of water-disintegrable hygiene items. The films produced from each heat-sensitive polymer are soluble in water at a temperature below the LCST and in particular at the temperature of tap water. The formulation of these heat-sensitive polymers with hydrophobic polymers also leads to films which are dispersible in an aqueous medium if the proportion of hydrophobic polymers is not excessively large.

The present invention also provides these water-dispersible or water-disintegrable films obtained by drying of a copolymer as defined above or prepared by a process as defined above, or of a mixture as defined above comprising at most 50% by weight of hydrophobic (co)polymers, based on all of the copolymers.

The invention also provides the use of a copolymer of the invention or prepared by a process as defined above as binder or binder component for fibrous sheets, or as a component of adhesives, or as a component of a compounded polymer material, in particular as a constituent of water-disintegrable hygiene items.

The invention also provides hygiene items, in particular disposable hygiene items, a constituent of which is the copolymer of the invention or prepared by a process as defined above, or the mixture as defined above, either as a water-soluble or water-disintegrable film, or as a binder used in the production of fibrous sheets which are incorporated into these items, or for the formulation of adhesives connecting the various constituents of the hygiene item, or as a component of the compounded polymer material forming the underwrap of the item.

The examples below illustrate the present invention, but do not limit its scope. The parts and percentages in these examples are expressed in terms of weight unless otherwise indicated, and the following abbreviations have been used:

AMA: methacrylic acid

MAPEG 8: monomer of formula:

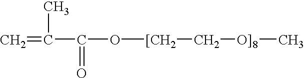

MAPEG 12: monomer of formula:

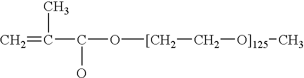

MAPEG 22: monomer of formula:

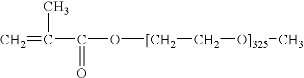

AMPS: monomer of formula:

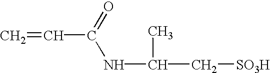

ADAMQUAT MC80: 80% strength by weight aqueous solution of acryloyloxyethyltrimethylammonium chloride

MAM: methyl methacrylate

MABu: butyl methacrylate

MALAU: lauryl methacrylate

\overline{n}OE: average number of ethylene oxide units

Determination of LCST:

The LCST is the temperature at which the product converts from an opaque dispersion (insoluble polymer) to a clear solution (soluble polymer).

If it is indicated that the polymer has an LOST of T° C., this means that the product obtained is an aqueous solution of water-soluble polymer it the temperature is below T° C. and that, on the other hand, above T° C. the polymer is insoluble in water and the product takes the form of dispersions of particles of insoluble polymer in water.

In all of the examples the LCST is determined visually during cooling of the product after synthesis.

### EXAMPLE 1

### Synthesis of a MAPEG 12/MAM/AMPS Copolymer (30% Molar in MAM)

A mixture consisting of:

444 parts of water;

83.93 parts of AMPS;

93.53 parts of MAPEG 12; and

23.48 parts of MAX;

is introduced, with stirring (150 rpm; anchor stirrer), into a 1 litre reactor, and the reactor is brought to a temperature of 80° C. with nitrogen flushing. When the temperature of the reaction medium is stable at 80° C., a first solution of initiator is introduced batchwise, and another solution of initiator is introduced via continuous feed during one hour and thirty minutes, the method being as follows:

(1) batchwise introduction of a solution of initiator comprising:

8 parts of water; and

0.984 part of ammonium persulphate;

(2) feed during one hour and thirty minutes of a solution of initiator comprising:

28 parts of water; and

3.936 parts of ammonium persulphate.

After one hour and thirty minutes of feed, the reaction is allowed to continue for a further half hour. The reactor is cooled to 20° C. and a polymer is obtained which is soluble in water and has the composition:

| COMPOSITION | MAPEG 12 | MAM | AMPS |
|---|---|---|---|
| by weight | 46.30 | 11.74 | 41.96 |
| molar | 18.20 | 30 | 51.80 |

This polymer is water-soluble and forms a translucent solution. It has a precipitation temperature comparable with an LCST of 50° C.

### EXAMPLE 2

### Synthesis of a MAPEG 12/MAM/AMPS Copolymer (25% Molar in MAM)

A mixture consisting of:

444 parts of water;

88.44 parts of AMPS;

93.51 parts of MAPEG 12; and

18.99 parts of MAM;

is introduced, with stirring (150 rpm; anchor stirrer), into a 1 litre reactor, and the reactor is brought to a temperature of 80° C. with nitrogen flushing. When the temperature of the reaction medium is stable at 80° C., a first solution of initiator is introduced batchwise, and another solution of initiator is introduced via continuous feed during one hour and thirty minutes, the method being as follows:

(1) batchwise introduction of a solution of initiator comprising:

8 parts of water; and

0.984 part of ammonium persulphate;

(2) feed during one hour and thirty minutes of a solution of initiator comprising:

28 parts of water; and

3.936 parts of ammonium persulphate.

After one hour and thirty minutes of feed, the reaction is allowed to continue for a further half hour. The reactor is cooled to 20° C. and a polymer is obtained which is soluble in water and has the composition:

| COMPOSITION | MAPEG 12 | MAM | AMPS |
|---|---|---|---|
| by weight | 46.29 | 9.49 | 44.22 |
| molar | 18.75 | 25 | 56.25 |

This polymer is water-soluble and forms a translucent solution. It has a precipitation temperature comparable with an LCST of from 55 to 56° C.

### EXAMPLE 3

### Synthesis of a MAPEG 12/MAM/AMPS Copolymer (20% Molar in MAM)

A mixture consisting of:

444 parts of water;

92.67 parts of AMPS;

93.52 parts of MAPEG 12; and

14.75 parts of MAM;

is introduced, with stirring (150 rpm; anchor stirrer), into a 1 litre reactor, and the reactor is brought to a temperature of 80° C. with nitrogen flushing. When the temperature of the reaction medium is stable at 80° C., a first solution of initiator is introduced batchwise, and another solution of initiator is introduced via continuous feed during one hour and thirty minutes, the method being as follows:

(1) batchwise introduction of a solution of initiator comprising:

8 parts of water; and

0.984 part of ammonium persulphate;

(2) feed during one hour and thirty minutes of a solution of initiator comprising:

28 parts of water; and

3.936 parts of ammonium persulphate.

After one hour and thirty minutes of feed, the reaction is allowed to continue for a further half hour. The reactor is cooled to 20° C. and a polymer is obtained which is soluble in water and has the composition:

| COMPOSITION | MAPEG 12 | MAM | AMPS |
|---|---|---|---|
| by weight | 46.29 | 7.38 | 46.33 |
| molar | 19.31 | 20 | 60.69 |

This polymer is water-soluble and forms a translucent solution. It has a precipitation temperature comparable with an LCST of from 62 to 63° C.

### EXAMPLE 4

### Synthesis of a MAPEG 12/MAM/AMPS Copolymer (15% Molar in MAM)

A mixture consisting of:

444 parts of water;

96.65 parts of AMPS;

93.53 parts of MAPEG 12; and

10.75 parts of MAM;

is introduced, with stirring (150 rpm; anchor stirrer), into a 1 litre reactor, and the reactor is brought to a temperature of 80° C. with nitrogen flushing. When the temperature of the reaction medium is stable at 80° C., a first solution of initiator is introduced batchwise, and another solution of initiator is introduced via continuous feed during one hour and thirty minutes, the method being as follows:

(1) batchwise introduction of a solution of initiator comprising:

8 parts of water; and

0.984 part of ammonium persulphate;

(2) feed during one hour and thirty minutes of a solution of initiator comprising:

28 parts of water; and

3.936 parts of ammonium persulphate.

After one hour and thirty minutes of feed, the reaction is allowed to continue for a further half hour. The reactor is cooled to 20° C. and a polymer is obtained which is soluble in water and has the composition:

| COMPOSITION | MAPEG 12 | MAM | AMPS |
|---|---|---|---|
| by weight | 46.30 | 5.38 | 48.33 |
| molar | 19.87 | 15 | 65.13 |

This polymer is water-soluble and forms a translucent solution. It has a precipitation temperature comparable with an LCST of from 62 to 71° C.

### EXAMPLE 5

### Synthesis of a MAPEG 12/MAM/AMPS Copolymer (10% Molar in MAM)

A mixture consisting of:

444 parts of water;

100.42 parts of AMPS:

93.54 parts of MAPEG 12; and

6.97 parts of MAM;

is introduced, with stirring (150 rpm; anchor stirrer), into a 1 litre reactor, and the reactor is brought to a temperature of 80° C. with nitrogen flushing. When the temperature of the reaction medium is stable at 80° C., a first solution of initiator is introduced batchwise, and another solution of initiator is introduced via continuous feed during one hour and thirty minutes, the method being as follows:

(1) batchwise introduction of a solution of initiator comprising:

8 parts of water; and

0.984 part of ammonium persulphate;

(2) feed during one hour and thirty minutes of a solution of initiator comprising:

28 parts of water; and

3.936 parts of ammonium persulphate.

After one hour and thirty minutes of feed, the reaction is allowed to continue for a further half hour. The reactor is cooled to 20° C. and a polymer is obtained which is soluble in water and has the composition:

| COMPOSITION | MAPEG 12 | MAM | AMPS |
|---|---|---|---|
| by weight | 46.30 | 3.49 | 50.21 |
| molar | 20.43 | 10 | 69.57 |

This polymer is water-soluble and forms a translucent solution. It has a precipitation temperature comparable with an LCST of 77° C.

### EXAMPLE 6

### Synthesis of a MAPEG 12/MAM/AMPS Copolymer (5% Molar in MAM)

A mixture consisting of:

444 parts of water;

104.02 parts of AMPS;

93.52 parts of MAPEG 12; and

3.39 parts of MAM;

is introduced, with stirring (150 rpm; anchor stirrer), into a 1 litre reactor, and the reactor is brought to a temperature of 80° C. with nitrogen flushing. When the temperature of the reaction medium is stable at 80° C., a first solution of initiator is introduced batchwise, and another solution of initiator is introduced via continuous feed during one hour and thirty minutes, the method being as follows:

(1) batchwise introduction of a solution of initiator comprising:

8 parts of water; and

0.984 part of ammonium persulphate;

(2) feed during one hour and thirty minutes of a solution of initiator comprising:

28 parts of water; and

3.936 parts of ammonium persulphate.

After one hour and thirty minutes of feed, the reaction is allowed to continue for a further half hour. The reactor is cooled to 20° C. and a polymer is obtained which is soluble in water and has the composition:

| COMPOSITION | MAPEG 12 | MAM | AMPS |
|---|---|---|---|
| by weight | 46.29 | 1.70 | 52.01 |
| molar | 20.98 | 5 | 74.02 |

This polymer is water-soluble and forms a translucent solution. It has a precipitation temperature comparable with an LCST of 86° C.

### EXAMPLE 7

### Synthesis of a MAPEG 12/MAM/AMPS Copolymer (35% Molar in MAM)

A mixture consisting of:

444 parts of water;

79.16 parts of AMPS;

93.52 parts of MAPEG 12; and

28.36 parts of MAM;

is introduced, with stirring (150 rpm; anchor stirrer), into a 1 litre reactor, and the reactor is brought to a temperature of 80° C. with nitrogen flushing. When the temperature of the reaction medium is stable at 80° C., a first solution of initiator is introduced batchwise, and another solution of initiator is introduced via continuous feed during one hour and thirty minutes, the method being as follows:

(1) batchwise introduction of a solution of initiator comprising:

8 parts of water; and

0.984 part of ammonium persulphate;

(2) feed during one hour and thirty minutes of a solution of initiator comprising:

28 parts of water; and

3.936 parts of ammonium persulphate.

After one hour and thirty minutes of feed, the reaction is allowed to continue for a further half hour. The reactor is cooled to 20° C. and a polymer is obtained which is soluble in water and has the composition:

| COMPOSITION | MAPEG 12 | MAM | AMPS |
|---|---|---|---|
| by weight | 46.29 | 14.13 | 39.58 |
| molar | 17.64 | 35 | 47.36 |

This polymer is water-soluble and forms a translucent solution. It has a precipitation temperature comparable with an LCST of from 40 to 42° C.

### REFERENCE EXAMPLE 8

### Synthesis of a MAPEG 8/AMPS Copolymer

302.12 parts of water are introduced with stirring (150 rpm; anchor stirrer) into a 1 litre reactor;

and the reactor is brought to a temperature of 80° C. with nitrogen flushing. When the temperature of the water is stable at 80° C., a solution of initiator and a solution of monomers are fed separately and simultaneously, using the following method:

(1) feed during three hours of a solution comprising:

104.50 parts of AMPS;

78.89 parts of MAPEG 8; and

99.60 parts of water;

(2) feed during three hours of a solution of initiator comprising:

36.52 parts of water; and

4.492 parts of ammonium persulphate.

After three hours of feed, the reaction is allowed to continue for a further two hours. The reactor is cooled to 20° C. and a polymer is obtained which is soluble in water and has the composition:

| COMPOSITION | MAPEG 8 | AMPS |
|---|---|---|
| by weight | 42.77 | 57.23 |
| molar | 25.50 | 74.50 |

The polymer is water-soluble and forms a translucent solution. It does not have a precipitation temperature comparable with an LCST.

### REFERENCE EXAMPLE 9

### Synthesis of a MAPEG 12/AMP Copolymer

A mixture consisting of:

444 parts of water;

104.02 parts of AMPS; and

93.52 parts of MAPEG 12;

is introduced, with stirring (150 rpm; anchor stirrer) into a 1 litre reactor and the reactor is brought to a temperature of 80° C. with nitrogen flushing. When the temperature of the reaction medium is stable at 80° C., a first solution of initiator is introduced batchwise and another solution of initiator is introduced by continuous feed during one hour and thirty minutes, the method being as follows:

(1) batchwise introduction of a solution of initiator comprising:

8 parts of water; and

0.984 part of ammonium persulphate;

(2) feed during one hour and thirty minutes of a solution of initiator comprising:

28 parts of water; and

3.936 parts of ammonium persulphate.

After one hour and thirty minutes of feed, the reaction is allowed to continue for a further half hour. The reactor is cooled to 20° C. and a polymer is obtained which is soluble in water and has the composition:

| COMPOSTTION | MAPEG 12 | AMPS |
|---|---|---|
| by weight | 47.09 | 52.91 |
| molar | 22.09 | 77.91 |

This polymer is water-soluble and forms a translucent solution. It does not have a precipitation temperature comparable with an LCST.

Without hydrophobic units, a MAPEG/AMPS copolymer is water-soluble and does not have a precipitation temperature.

At an equivalent proportion of MAPEG 12 by weight, an increase in hydrophobic character via addition of MAM is seen in a reduction in the precipitation temperature of the polymer formed.

### EXAMPLE 10

### Synthesis of a MAPEG 12/MABU/AMPS Copolymer (5% Molar in MABU)

A mixture consisting of:

444 parts of water;

105.37 parts of AMPS;

90.71 parts of MAPEG 12; and

4.84 parts of MABU;

is introduced, with stirring (150 rpm; anchor stirrer), into a 1 litre reactor, and the reactor is brought to a temperature of 80° C. with nitrogen flushing. When the temperature of the reaction medium is stable at 80° C., a first solution of initiator is introduced batchwise, and another solution of initiator is introduced via continuous feed during one hour and thirty minutes, the method being as follows:

(5) batchwise introduction of a solution of initiator comprising:

8 parts of water; and

0.984 part of ammonium persulphate;

(6) feed during one hour and thirty minutes of a solution of initiator comprising:

28 parts of water; and

3.936 parts of ammonium persulphate.

After one hour and thirty minutes of feed, the reaction is allowed to continue for a further half hour. The reactor is cooled to 20° C. and a polymer is obtained which is soluble in water and has the composition:

| COMPOSITION | MAPEG 12 | MABU | AMPS |
|---|---|---|---|
| by weight | 44.90 | 2.42 | 52.68 |
| molar | 20.28 | 5 | 74.72 |

This polymer is water-soluble and forms a translucent solution. It has a precipitation temperature comparable with an LCST of 80° C.

### EXAMPLE 11

### Synthesis of a MAPEG 12/MABU/AMPS Copolymer (10% Molar in MABU)

A mixture consisting of:

444 parts of water;

100.39 parts of AMPS;

90.68 parts of MAPEG 12; and

9.83 parts of MABU;

is introduced, with stirring (150 rpm; anchor stirrer), into a 1 litre reactor, and the reactor is brought to a temperature of 80° C. with nitrogen flushing. When the temperature of the reaction medium is stable at 80° C., a first solution of initiator is introduced batchwise, and another solution of initiator is introduced via continuous feed during one hour and thirty minutes, the method being as follows:

(1) batchwise introduction of a solution of initiator comprising:

8 parts of water; and

0.984 part of ammonium persulphate;

(2) feed during one hour and thirty minutes of a solution of initiator comprising:

28 parts of water; and

3.936 parts of ammonium persulphate.

After one hour and thirty minutes of feed, the reaction is allowed to continue for a further half hour. The reactor is cooled to 20° C. and a polymer is obtained which is soluble in water and has the composition:

| COMPOSITION | MAPEG 12 | MABU | AMPS |
|---|---|---|---|
| by weight | 44.89 | 4.92 | 50.20 |
| molar | 19.95 | 10 | 70.05 |

This polymer is water-soluble and forms a slightly cloudy dispersion. It has a precipitation temperature comparable with an LCST of about 80° C.

### EXAMPLE 12 (COMPARATIVE)

### Synthesis of a MAPEG 12/MABU/AMPS Copolymer (20% Molar in MABU)

A mixture consisting of:

444 parts of water;

89.88 parts of AMPS;

90.71 parts of MAPEG 12; and

20.32 parts of MABU;

is introduced, with stirring (150 rpm; anchor stirrer), into a 1 litre reactor, and the reactor is brought to a temperature of 80° C. with nitrogen flushing. When the temperature of the reaction medium is stable at 80° C., a first solution of initiator is introduced batchwise, and another solution of initiator is introduced via continuous feed during one hour and thirty minutes, the method being as follows:

(1) batchwise introduction of a solution of initiator comprising:

8 parts of water; and

0.984 part of ammonium persulphate;

(2) feed during one hour and thirty minutes of a solution of initiator comprising:

28 parts of water; and

3.936 parts of ammonium persulphate.

After one hour and thirty minutes of feed, the reaction is allowed to continue for a further half hour. The reactor is cooled to 20° C. and a polymer is obtained which is insoluble in water and has the composition.

| COMPOSITION | MAPEG 12 | MABU | AMPS |
|---|---|---|---|
| by weight | 44.90 | 10.16 | 44.94 |
| molar | 19.31 | 20 | 60.69 |

This polymer is not water-soluble and forms an opaque dispersion. It does not have a precipitation temperature comparable with an LCST.

The marked hydrophobic nature of the MABU impedes the formation of water-soluble polymers when the molar percentage of hydrophobic material is high (above 5%). At a high molar percentage of MABU, the product is a dispersion whose opacity increases with the proportion of hydrophobic monomer.

### EXAMPLE 13 (COMPARATIVE)

### Synthesis of a MAPEG 12/MALAU/AMPS Copolymer (5% Molar in MALAU)

A mixture consisting of:

444 parts of water;

101.02 parts of AMPS;

80.82 parts of MAPEG 12; and

9.07 parts of MALAU;

is introduced, with stirring (150 rpm; anchor stirrer), into a 1 litre reactor, and the reactor is brought to a temperature of 80° C. with nitrogen flushing. When the temperature of the reaction medium is stable at 80° C., a first solution of initiator is introduced batchwise, and another solution of initiator is introduced via continuous feed during one hour and thirty minutes, the method being as follows:

(1) batchwise introduction of a solution of initiator comprising:

8 parts of water; and

0.984 part of ammonium persulphate;

(2) feed during one hour and thirty minutes of a solution of initiator comprising:

28 parts of water; and

3.936 parts of ammonium persulphate.

After one hour and thirty minutes of feed, the reaction is allowed to continue for a further half hour. The reactor is cooled to 20° C. and a polymer is obtained which is insoluble in water and has the composition:

| COMPOSITION | MAPEG 12 | MALAU | AMPS |
|---|---|---|---|
| by weight | 44.96 | 4.53 | 50.51 |
| molar | 20.28 | 5 | 74.72 |

This polymer is not water-soluble and forms an opaque dispersion. It does not have a precipitation temperature comparable with an LCST.

### EXAMPLE 14 (COMPARATIVE)

### Synthesis of a MAPEG 12/MALAU/AMPS Copolymer (1% Molar in MALAU)

A mixture consisting of:

444 parts of water;

108.36 parts of AMPS;

9071 parts of MAPEG 12; and

1.84 parts of MALAU;

is introduced, with stirring (150 rpm; anchor stirrer), into a 1 litre reactor, and the reactor is brought to a temperature of 80° C. with nitrogen flushing. When the temperature of the reaction medium is stable at 80° C., a first solution of initiator is introduced batchwise, and another solution of initiator is introduced via continuous feed during one hour and thirty minutes, the method being as follows:

(1) batchwise introduction of a solution of initiator comprising:

8 parts of water; and

0.984 part of ammonium persulphate;

(2) feed during one hour and thirty minutes of a solution of initiator comprising:

28 parts of water; and

3.936 parts of ammonium persulphate.

After one hour and thirty minutes of feed, the reaction is allowed to continue for a further half hour. The reactor is cooled to 20° C. and a polymer is obtained which is insoluble in water and has the composition:

| COMPOSITION | MAPEG 12 | MALAU | AMPS |
|---|---|---|---|
| by weight | 44.90 | 0.92 | 54.18 |
| molar | 20.68 | 1 | 78.35 |

This polymer is not water-soluble and forms an opaque and relatively viscous dispersion. It does not have a precipitation temperature comparable with an LCST.

### EXAMPLE 15 (COMPARATIVE)

### Synthesis of a MAPEG 12/MALAU/AMPS Copolymer (0.20% Molar in MALAU)

A mixture consisting of:

444 parts of water;

109.88 parts of AMPS;

90.65 parts of MAPEG 12; and

0.37 parts of MALAU;

is introduced, with stirring (150 rpm; anchor stirrer), into a 1 litre reactor, and the reactor is brought to a temperature of 80° C. with nitrogen flushing. When the temperature of the reaction medium is stable at 80° C., a first solution of initiator is introduced batchwise, and another solution of initiator is introduced via continuous feed during one hour and thirty minutes, the method being as follows:

(1) batchwise introduction of a solution of initiator comprising:

8 parts of water; and

0.984 part of ammonium persulphate;

(2) feed during one hour and thirty minutes of a solution of initiator comprising:

28 parts of water; and

3.936 parts of ammonium persulphate.

After one hour and thirty minutes of feed, the reaction is allowed to continue for a further half hour. The reactor is cooled to 20° C. and a polymer is obtained which is insoluble in water and has the composition:

| COMPOSITION | MAPEG 12 | MALAU | AMPS |
|---|---|---|---|
| by weight | 44.87 | 0.18 | 54.94 |
| molar | 20.60 | 0.20 | 79.20 |

This polymer is not water-soluble and forms a slightly cloudy dispersion. It does not have a precipitation temperature comparable with an LCST.

The use of MALAU does not permit synthesis of heat-sensitive water-soluble polymers by this method. At a low molar proportion of MALAU, the final product takes the form of an opaque dispersion forming no precipitate at high temperature (above 90° C.). This series of syntheses confirms the observations made when using MABU; the three hydrophobic monomers used can be classified in order of increasingly hydrophobic properties:

MAM<MABU<MALAU

The greater the hydrophobic character of the monomer, the more difficult it is to dissolve the polymer formed in an aqueous phase.

Whereas it is possible to synthesize a water-soluble AMPS/MAM/MAPEG 12 polymer with a molar proportion of 5% of MAM, the mole for mole substitution of the MAM by MALAU leads to an opaque dispersion with no precipitate formed when the temperature rises.

### EXAMPLE 16 (COMPARATIVE)

### Synthesis of a MAPEG 12/MAM/AMPS Copolymer (Molar Ratio n_{(AMPS)}/n_{(MAPEG 12)}=7.75)

A mixture consisting of:

444 parts of water;

122.03 parts of AMPS;

49.94 parts of MAPEG 12; and

28.53 parts of MAM;

is introduced, with stirring (150 rpm; anchor stirrer), into a 1 litre reactor, and the reactor is brought to a temperature of 80° C. with nitrogen flushing. When the temperature of the reaction medium is stable at 80° C., a first solution of initiator is introduced batchwise, and another solution of initiator is introduced via continuous feed during one hour and thirty minutes, the method being as follows:

(1) batchwise introduction of a solution of initiator comprising:

8 parts of water; and

0.984 part of ammonium persulphate;

(2) feed during one hour and thirty minutes of a solution of initiator comprising:

28 parts of water; and

3.936 parts of ammonium persulphate.

After one hour and thirty minutes of feed, the reaction is allowed to continue for a further half hour. The reactor is cooled to 20° C. and a polymer is obtained which is insoluble in water and has the composition:

| COMPOSITION | MAPEG 12 | MAM | AMPS |
|---|---|---|---|
| by weight | 24.72 | 14.26 | 61.02 |
| molar | 8 | 30 | 62 |

This polymer is not water-soluble and forms an opaque dispersion. It does not have a precipitation temperature comparable with an LCST.

### EXAMPLE 17

### Synthesis of a MAPEG 12/MAM/AMPS Copolymer (Molar Ratio n_{(AMPS)}/n_{(MAPEG 12)}=5.67)

A mixture consisting of:

444 parts of water;

111.25 parts of AMPS;

62.27 parts of MAPEG 12; and

27.10 parts of MAM;

is introduced, with stirring (150 rpm; anchor stirrer), into a 1 litre reactor, and the reactor is brought to a temperature of 80° C. with nitrogen flushing. When the temperature of the reaction medium is stable at 80° C., a first solution of initiator is introduced batchwise, and another solution of initiator is introduced via continuous feed during one hour and thirty minutes, the method being as follows:

(1) batchwise introduction of a solution of initiator comprising:

8 parts of water; and

0.984 part of ammonium persulphate;

(2) feed during one hour and thirty minutes of a solution of initiator comprising:

28 parts of water; and

3.936 parts of ammonium persulphate.

After one hour and thirty minutes of feed, the reaction is allowed to continue for a further half hour. The reactor is cooled to 20° C. and a polymer is obtained which is soluble in water and has the composition:

| COMPOSITION | MAPEG 12 | MAM | AMPS |
|---|---|---|---|
| by weight | 30.82 | 13.55 | 55.63 |
| molar | 10.50 | 30 | 59.50 |

This polymer is water-soluble and forms a translucent solution. It has a precipitation temperature comparable with an LCST of from 30 to 32° C.

### EXAMPLE 18

### Synthesis of a MAPEG 12/MAM/AMPS Copolymer (Molar Ratio (n_{(AMPS)}/n_{(MAPEG 12)}=4.38)

A mixture consisting of:

444 parts of water;

101.50 parts of AMPS;

73.43 parts of MAPEG 12; and

25.81 parts of MAM;

is introduced, with stirring (150 rpm; anchor stirrer), into a 1 litre reactor, and the reactor is brought to a temperature of 80° C. with nitrogen flushing. When the temperature of the reaction medium is stable at 80° C., a first solution of initiator is introduced batchwise and another solution of initiator in introduced via continuous feed during one hour and thirty minutes, the method being as follows:

(1) batchwise introduction of a solution of initiator comprising:

8 parts of water; and

0.984 part of ammonium persulphate;

(2) feed during one hour and thirty minutes of a solution of initiator comprising:

28 parts of water; and

3.936 parts of ammonium persulphate.

After one hour and thirty minutes of feed, the reaction is allowed to continue for a further half hour. The reactor is cooled to 20° C. and a polymer is obtained which is soluble in water and has the composition:

| COMPOSITION | MAPEG 12 | MAM | AMPS |
|---|---|---|---|
| by weight | 36.35 | 12.90 | 50.75 |
| molar | 13 | 30 | 57 |

This polymer is water-soluble and forms a translucent solution. It has a precipitation temperature comparable with an LCST of from 35 to 38° C.

### EXAMPLE 19

### Synthesis of a MAPEG 12/MAM/AMPS Copolymer (Molar Ratio n_{(AMPS)}/n_{(MAPEG 12)}=2.85)

A mixture consisting of:

444 parts of water;

83.93 parts of AMPS;

93.53 parts of MAPEG 12; and

23.48 parts of MAM;

is introduced, with stirring (150 rpm; anchor stirrer), into a 1 litre reactor, and the reactor is brought to a temperature of 80° C. with nitrogen flushing. When the temperature of the reaction medium is stable at 80° C., a first solution of initiator is introduced batchwise, and another solution of initiator is introduced via continuous feed during one hour and thirty minutes, the method being as follows:

(1) batchwise introduction of a solution of initiator comprising:

8 parts of water; and

0.984 part of ammonium persulphate;

(2) feed during one hour and thirty minutes of a solution of initiator comprising:

28 parts of water; and

3.936 parts of ammonium persulphate.

After one hour and thirty minutes of feed, the reaction is allowed to continue for a further half hour. The reactor is cooled to 20° C. and a polymer is obtained which is soluble in water and has the composition:

| COMPOSITION | MAPEG 12 | MAM | AMPS |
|---|---|---|---|
| by weight | 46.30 | 11.74 | 41.96 |
| molar | 18.20 | 30 | 51.80 |

This polymer is water-soluble and forms a translucent solution. It has a precipitation temperature comparable with an LCST of 50° C.

### EXAMPLE 20

### Synthesis of a MAPEG 12/MAM/AMPS Copolymer (Molar Ratio n_{(AMPS)}/n_{(MAPEG 12)}=1.92)

A mixture consisting of:

444 parts of water;

67.72 parts of AMPS;

112.07 parts of MAPEG 12; and

21.34 parts of MAM;

is introduced, with stirring (150 rpm; anchor stirrer), into a 1 litre reactor, and the reactor is brought to a temperature of 80° C. with nitrogen flushing. When the temperature of the reaction medium is stable at 80° C., a first solution of initiator is introduced batchwise, and another solution of initiator is introduced via continuous feed during one hour and thirty minutes, the method being as follows:

(1) batchwise introduction of a solution of initiator comprising:

8 parts of water; and

0.984 part of ammonium persulphate;

(2) feed during one hour and thirty minutes of a solution of initiator comprising:

28 parts of water; and

3.936 parts of ammonium persulphate.

After one hour and thirty minutes of feed, the reaction is allowed to continue for a further half hour. The reactor is cooled to 20° C. and a polymer is obtained which is soluble in water and has the composition:

| COMPOSITION | MAPEG 12 | MAM | AMPS |
|---|---|---|---|
| by weight | 55.47 | 10.67 | 33.86 |
| molar | 24 | 30 | 46 |

This polymer is water-soluble and forms a translucent solution. It has a precipitation temperature comparable with an LCST of from 61 to 62° C.

### EXAMPLE 21

### Synthesis of a MAPEG 12/MAM/AMPS Copolymer (Molar Ratio n_{(AMPS)}/n_{(MAPEG 12)}=1.19)

A mixture consisting of:

444 parts of water;

49.68 parts of AMPS;

132.70 parts of MAPEG 12; and

18.95 parts of MAM;

is introduced, with stirring (150 rpm; anchor stirrer), into a 1 litre reactor, and the reactor is brought to a temperature of 80° C. with nitrogen flushing. When the temperature of the reaction medium is stable at 80° C., a first solution of initiator is introduced batchwise, and another solution of initiator is introduced via continuous feed during one hour and thirty minutes, the method being as follows:

(1) batchwise introduction of a solution of initiator comprising:

8 parts of water; and

0.984 part of ammonium persulphate;

(2) feed during one hour and thirty minutes of a solution of initiator comprising:

28 parts of water; and

3.936 parts of ammonium persulphate.

After one hour and thirty minutes of feed, the reaction is allowed to continue for a further half hour. The reactor is cooled to 20° C. and a polymer is obtained which is soluble in water and has the composition:

| COMPOSITION | MAPEG 12 | MAM | AMPS |
|---|---|---|---|
| by weight | 65.69 | 9.47 | 24.84 |
| molar | 32 | 30 | 38 |

This polymer is water-soluble and forms a translucent solution. It has a precipitation temperature comparable with an LCST of from 70 to 72° C.

### EXAMPLE 22

### Synthesis of a MAPEG 12/MAM/AMPS Copolymer (Molar Ratio n_{(AMPS)}/n_{(MAPEG 12)}=0.75)

A mixture consisting of:

444 parts of water;

35.27 parts of AMPS;

149.18 parts of MAPEG 12; and

17.04 parts of MAM;

is introduced, with stirring (150 rpm; anchor stirrer), into a 1 litre reactor, and the reactor is brought to a temperature of 80° C. with nitrogen flushing. When the temperature of the reaction medium is stable at 80° C., a first solution of initiator is introduced batchwise, and another solution of initiator is introduced via continuous feed during one hour and thirty minutes, the method being as follows:

(1) batchwise introduction of a solution of initiator comprising:

8 parts of water; and

0.984 part of ammonium persulphate;

(2) feed during one hour and thirty minutes of a solution of initiator comprising:

28 parts of water; and

3.936 parts of ammonium persulphate.

After one hour and thirty minutes of feed, the reaction is allowed to continue for a further half hour. The reactor is cooled to 20° C. and a polymer is obtained which is soluble in water and has the composition:

| COMPOSITION | MAPEG 12 | MAM | AMPS |
|---|---|---|---|
| by weight | 73.84 | 8.52 | 17.64 |
| molar | 40 | 30 | 30 |

This polymer forms a translucent gel. It has a precipitation temperature comparable with an LCST of 80° C.

For an equivalent molar percentage of MAM, an increase in the molar ratio n_{(AMPS)}/n_{(MAPEG 12)} brings about a decrease in the precipitation temperature.

### EXAMPLE 23

### Synthesis of a MAPEG 8/MAM/AMPS Copolymer (Molar Ratio n_{(AMPS)}n/_{(MAPEG 8)}=2.29)

A mixture consisting of:

444 parts of water;

90.99 parts of AMPS;

88.77 parts of MAPEG 8; and

21.13 parts of MAM;

is introduced, with stirring (150 rpm; anchor stirrer), into a 1 litre reactor, and the reactor is brought to a temperature of 80° C. with nitrogen flushing. When the temperature of the reaction medium is stable at 80° C., a first solution of initiator is introduced batchwise, and another solution of initiator is introduced via continuous feed during one hour and thirty minutes, the method being as follows:

(1) batchwise introduction of a solution of initiator comprising:

8 parts of water; and

0.984 part of ammonium persulphate;

(2) feed during one hour and thirty minutes of a solution of initiator comprising:

28 parts of water; and

3.936 parts of ammonium persulphate.

After one hour and thirty minutes of feed, the reaction is allowed to continue for a further half hour. The reactor is cooled to 20° C. and a polymer is obtained which is soluble in water and has the composition:

| COMPOSITION | MAPEG 8 | MAM | AMPS |
|---|---|---|---|
| by weight | 43.94 | 10.57 | 45.49 |
| molar | 23 | 25 | 52 |

This polymer is water-soluble and takes the form of a translucent solution. It has a precipitation temperature comparable with an LCST of from 37 to 38° C.

### EXAMPLE 24

### Synthesis of a MAPEG 8/MAM/AMPS Copolymer (Molar Ratio n_{(AMPS)}/n(MAPEG 8)=2.57)

A mixture consisting of:

444 parts of water;

96.49 parts of AMPS;

82.76 parts of MAPEG 8; and

21.58 parts of MAM;

is introduced, with stirring (150 rpm; anchor stirrer), into a 1 litre reactor, and the reactor is brought to a temperature of 80° C. with nitrogen flushing. When the temperature of the reaction medium is stable at 80° C., a first solution of initiator is introduced batchwise, and another solution of initiator is introduced via continuous feed during one hour and thirty minutes, the method being as follows:

(1) batchwise introduction of a solution of initiator comprising:

8 parts of water; and

0.984 part of ammonium persulphate;

(2) feed during one hour and thirty minutes of a solution of initiator comprising:

28 parts of water; and

3.936 parts of ammonium persulphate.

After one hour and thirty minutes of feed, the reaction is allowed to continue for a further half hour. The reactor is cooled to 20° C. and a polymer is obtained which is soluble in water and has the composition.

| COMPOSITION | MAPEG 8 | MAM | AMPS |
|---|---|---|---|
| by weight | 40.97 | 10.79 | 48.24 |
| molar | 21 | 25 | 54 |

This polymer is water-soluble and forms a translucent solution. It has a precipitation temperature comparable with an LCST of 34° C.

### EXAMPLE 25

### Synthesis of a MAPEG 8/MAM/AMPS Copolymer (Molar Ratio n_{(AMPS)}/n_{(MAPEG 8)}=3.04)

A mixture consisting of:

444 parts of water;

102.96 parts of AMPS;

75.69 parts of MAPEG 8; and

22.11 parts of MAM;

is introduced, with stirring (150 rpm; anchor stirrer), into a 1 litre reactor, and the reactor is brought to a temperature of 80° C. with nitrogen flushing. When the temperature of the reaction medium is stable at 80° C., a first solution of initiator is introduced batchwise, and another solution of initiator is introduced via continuous feed during one hour and thirty minutes, the method being as follows:

(1) batchwise introduction of a solution of initiator comprising:

8 parts of water; and

0.984 part of ammonium persulphate;

(2) feed during one hour and thirty minutes of a solution of initiator comprising:

28 parts of water; and

3.936 parts of ammonium persulphate.

After one hour and thirty minutes of feed, the reaction is allowed to continue for a further half hour. The reactor is cooled to 20° C. and a polymer is obtained which is soluble in water and has the composition:

| COMPOSITION | MAPEG 8 | MAN | AMPS |
|---|---|---|---|
| by weight | 37.47 | 11.05 | 51.48 |
| molar | 18.75 | 25 | 56.25 |

This polymer is water-soluble and forms a translucent solution. It has a precipitation temperature comparable with an LCST of from 26 to 27° C.

### EXAMPLE 26

### Synthesis of a MAPEG 8/MAM/AMPS Copolymer (Molar Ratio n_{(AMPS)}/n_{(MAPEG 8)}=4.41)

A mixture consisting of:

444 parts of water;

117.71 parts of AMPS;

59.58 parts of MAPEG 8; and

23.31 parts of MAM;

is introduced, with stirring (150 rpm; anchor stirrer), into a 1 litre reactor, and the reactor is brought to a temperature of 80° C. with nitrogen flushing. When the temperature of the reaction medium is stable at 80° C., a first solution of initiator is introduced batchwise, and another solution of initiator is introduced via continuous feed during one hour and thirty minutes, the method being as follows:

(1) batchwise introduction of a solution of initiator comprising:

8 parts of water; and

0.984 part of ammonium persulphate;

(2) feed during one hour and thirty minutes of a solution of initiator comprising:

28 parts of water; and

3.936 parts of ammonium persulphate.

After one hour and thirty minutes of feed, the reaction is allowed to continue for a further half hour. The reactor is cooled to 20° C. and a polymer is obtained which is insoluble in water and has the composition:

| COMPOSITION | MAPEG 8 | MAM | AMPS |
|---|---|---|---|
| by weight | 26.49 | 11.65 | 58.85 |
| molar | 14 | 25 | 61 |

This polymer is not water-soluble and forms an opaque dispersion at ambient temperature. It has a precipitation temperature comparable with an LCST at a temperature below 15° C.

At an equivalent molar percentage of MAM, an increase in the molar ratio n_{(AMPS)}/n_{(MAPEG 8)} brings about a decrease in the precipitation temperature.

These results confirm those obtained using MAPEG 12. When the ratio n_{(AMPS)}/n_{(MAPEG 8)} is high the precipitation temperature of the resultant polymer in aqueous solution is low (below 15° C.). A dispersion is obtained, the opacity of which increases with the value of the molar ratio n_{(AMPS)}/n_{(MAPEG 8).}

### EXAMPLE 27

### Synthesis of a MAPEG 8/MAM/AMPS Copolymer

A mixture consisting of:

444 parts of water;

102.96 parts of AMPS;

75.69 parts of MAPEG 8; and

22.11 parts of MAM;

is introduced, with stirring (150 rpm; anchor stirrer), into a 1 litre reactor, and the reactor is brought to a temperature of 80° C. with nitrogen flushing. When the temperature of the reaction medium is stable at 80° C., a first solution of initiator is introduced batchwise, and another solution of initiator is introduced via continuous feed during one hour and thirty minutes, the method being as follows:

(1) batchwise introduction of a solution of initiator comprising:

8 parts of water; and

0.984 part of ammonium persulphate;

(2) feed during one hour and thirty minutes of a solution of initiator comprising:

28 parts of water; and

3.936 parts of ammonium persulphate.

After one hour and thirty minutes of feed, the reaction is allowed to continue for a further half hour. The reactor is cooled to 20° C. and a polymer is obtained which is soluble in water and has the composition:

| COMPOSITION | MAPEG 8 | MAM | AMPS |
|---|---|---|---|
| by weight | 37.47 | 11.05 | 51.48 |
| molar | 18.75 | 25 | 56.25 |

This polymer is water-soluble and forms a translucent solution. It has a precipitation temperature comparable with an LCST at a temperature below 26 to 27° C.

### EXAMPLE 28

### Synthesis of a MAPEG 8/MAM/AMPS/ADAMQUAT MC80 Copolymer

A mixture consisting of:

444 parts of water;

97.64 parts of AMPS;

75.83 parts of MAPEG 8;

22.15 parts of MAM; and

6.43 parts of ADAMQUAT MC80

is introduced, with stirring (150 rpm; anchor stirrer), into a 1 litre reactor, and the reactor is brought to a temperature of 80° C. with nitrogen flushing. When the temperature of the reaction medium is stable at 80° C., a first solution of initiator is introduced batchwise, and another solution of initiator is introduced via continuous feed during one hour and thirty minutes, the method being as follows:

(1) batchwise introduction of a solution of initiator comprising:

8 parts of water; and

0.984 part of ammonium persulphate;

(2) feed during one hour and thirty minutes of a solution of initiator comprising:

28 parts of water; and

3.936 parts of ammonium persulphate.

After one hour and thirty minutes of feed, the reaction is allowed to continue for a further half hour. The reactor is cooled to 20° C. and a polymer is obtained which is soluble in water and has the composition:

| COMPOSITION | MAPEG 8 | MAM | AMPS | ADAMQUAT MC80 |
|---|---|---|---|---|
| by weight | 37.54 | 11.07 | 48.82 | 2.57 |
| molar | 18.75 | 25 | 53.25 | 3 |

This polymer is water-soluble and forms a translucent solution. It has a precipitation temperature comparable with an LCST of 50° C.

### EXAMPLE 29

### Synthesis of a MAPEG 8/MAM/AMPS/AMA Copolymer

A mixture consisting of:

444 parts of water;

89.44 parts of AMPS;

79.97 parts of MAPEG 8;

23.36 parts of MAM; and

8.03 parts of AMA;

is introduced, with stirring (150 rpm; anchor stirrer), into a 1 litre reactor, and the reactor is brought to a temperature of 80° C. with nitrogen flushing. When the temperature of the reaction medium is stable at 80° C., a first solution of initiator is introduced batchwise, and another solution of initiator is introduced via continuous feed during one hour and thirty minutes, the method being as follows:

(1) batchwise introduction of a solution of initiator comprising:

8 parts of water; and

0.984 part of ammonium persulphate;

(2) feed during one hour and thirty minutes of a solution of initiator comprising:

28 parts of water; and

3.936 parts of ammonium persulphate.

After one hour and thirty minutes of feed, the reaction is allowed to continue for a further half hour. The reactor is cooled to 20° C. and a polymer is obtained which is soluble in water and has the composition:

| COMPOSITION | MAPEG 8 | MAM | AMPS | AMA |
|---|---|---|---|---|
| by weight | 39.59 | 11.68 | 44.72 | 4.02 |
| molar | 18.75 | 25 | 46.25 | 10 |

This polymer is water-soluble and forms a translucent solution. It has a precipitation temperature comparable with an LCST of from 13 to 15° C.

### EXAMPLE 30

### Synthesis of a MAPEG 12/MAM/AMPS Copolymer

A mixture consisting of:

444 parts of water;

88.44 parts of AMPS;

93.51 parts of MAPEG 12; and

18.99 parts of MAM;

is introduced, with stirring (150 rpm; anchor stirrer), into a 1 litre reactor, and the reactor is brought to a temperature of 80° C. with nitrogen flushing. When the temperature of the reaction medium is stable at 80° C., a first solution of initiator is introduced batchwise, and another solution of initiator is introduced via continuous feed during one hour and thirty minutes, the method being as follows:

(1) batchwise introduction of a solution of initiator comprising:

8 parts of water; and

0.984 part of ammonium persulphate;

(2) feed during one hour and thirty minutes of a solution of initiator comprising:

28 parts of water; and

3.936 parts of ammonium persulphate.

After one hour and thirty minutes of feed, the reaction is allowed to continue for a further half hour. The reactor is cooled to 20° C. and a polymer is obtained which is soluble in water and has the composition:

| COMPOSITION | MAPEG 12 | MAM | AMPS |
|---|---|---|---|
| by weight | 46.29 | 9.49 | 44.22 |
| molar | 18.75 | 25 | 56.25 |

| COMPOSITION | MAPEG 12 | MAM | AMPS | AMA |
|---|---|---|---|---|
| by weight | 48.51 | 9.95 | 38.11 | 3.42 |
| molar | 18.75 | 25 | 46.25 | 10 |

This polymer is water-soluble and forms a translucent solution. It has a precipitation temperature comparable with an LCST of from 45 to 47° C.

### EXAMPLE 32

### Synthesis of a MAPEG 12/MAM/AMPS/AMA Copolymer

A mixture consisting of:

445 parts of water;

55.83 parts of AMPS;

103.7 parts of MAPEG 12;

26.03 parts of MAM; and

15.47 parts of AMA;

is introduced, with stirring (150 rpm; anchor stirrer), into a 1 litre reactor, and the reactor is brought to a temperature of 80° C. with nitrogen flushing. When the temperature of the reaction medium is stable at 80° C., a first solution of initiator is introduced batchwise, and another solution of initiator is introduced via continuous feed during one hour and thirty minutes, the method being as follows:

(1) batchwise introduction of a solution of initiator comprising:

8 parts of water; and

0.984 part of ammonium persulphate;

(2) feed during one hour and thirty minutes of a solution of initiator comprising:

28 parts of water; and

3.936 parts of ammonium persulphate.

After one hour and thirty minutes of feed, the reaction is allowed to continue for a further half hour. The reactor is cooled to 20° C. and a polymer is obtained which is soluble in water and has the composition:

| COMPOSITION | MAPEG 12 | MAM | AMPS | AMA |
|---|---|---|---|---|
| by weight | 51.33 | 13.02 | 27.92 | 7.73 |
| molar | 18.2 | 30.0 | 31.08 | 20.72 |

This polymer is water-soluble and forms a translucent solution. It has a precipitation temperature comparable with an LCST of from 25 to 27° C.

### EXAMPLE 33

### Synthesis of a MAPEG 12/MAM/AMPS Copolymer

A mixture consisting of:

444 parts of water;

83.93 parts of AMPS;

93.53 parts of MAPEG 12; and

23.48 parts of MAM;

is introduced, with stirring (150 rpm; anchor stirrer), into a 1 litre reactor, and the reactor is brought to a temperature of 80° C. with nitrogen flushing. When the temperature of the reaction medium is stable at 80° C., a first solution of initiator is introduced batchwise, and another solution of initiator is introduced via continuous feed during one hour and thirty minutes, the method being as follows:

(1) batchwise introduction of a solution of initiator comprising:

8 parts of water; and

0.984 part of ammonium persulphate;

(2) feed during one hour and thirty minutes of a solution of initiator comprising:

28 parts of water; and

3.936 parts of ammonium persulphate.

After one hour and thirty minutes of feed, the reaction is allowed to continue for a further half hour. The reactor is cooled to 20° C. and a polymer is obtained which is soluble in water and has the composition:

| COMPOSITION | MAPEG 12 | MAM | AMPS |
|---|---|---|---|
| by weight | 46.30 | 11.74 | 41.96 |
| molar | 18.20 | 30 | 51.80 |

This polymer is water-soluble and forms a translucent solution. It has a precipitation temperature comparable with an LCST of 50° C.

### EXAMPLE 34

### Synthesis of a MAPEG 12/MAM/AMPS Copolymer (0-5% of Mercaptoethanol by Weight, Based on the Monomers)

A mixture consisting of:

444 parts of water;

83.93 parts of AMPS;

93.53 parts of MAPEG 12;

23.48 parts of MAM; and

1.02 parts of Mercaptoethanol;

is introduced, with stirring (150 rpm; anchor stirrer), into a 1 litre reactor, and the reactor is brought to a temperature of 80° C. with nitrogen flushing. When the temperature of the reaction medium is stable at 80° C., a first solution of initiator is introduced batchwise, and another solution of initiator is introduced via continuous feed during one hour and thirty minutes, the method being as follows:

(1) batchwise introduction of a solution of initiator comprising:

8 parts of water; and

0.984 part of ammonium persulphate;

(2) feed during one hour and thirty minutes of a solution of initiator comprising:

28 parts of water; and

3.936 parts of ammonium persulphate.

After one hour and thirty minutes of feed, the reaction is allowed to continue for a further half hour. The reactor is cooled to 20° C. and a polymer is obtained which is soluble in water and has the composition:

| COMPOSITION | MAPEG 12 | MAM | AMPS |
|---|---|---|---|
| by weight | 46.30 | 11.74 | 41.96 |
| molar | 18.20 | 30 | 51.80 |

This polymer is water-soluble and forms a translucent solution. It has a precipitation temperature comparable with an LCST of 73° C.

### EXAMPLE 35

### Synthesis of a MAPEG 12/MAM/AMPS Copolymer (1.4% of Mercaptoethanol by Weight, Based on the Monomers)

A mixture consisting of:

444 parts of water;

83.93 parts of AMPS;

93.53 parts of MAPEG 12;

23.48 parts of MAM; and

2.86 parts of mercaptoethanol;

is introduced, with stirring (150 rpm; anchor stirrer), into a 1 litre reactor, and the reactor is brought to a temperature of 80° C. with nitrogen flushing. When the temperature of the reaction medium is stable at 80° C., a first solution of initiator is introduced batchwise, and another solution of initiator is introduced via continuous feed during one hour and thirty minutes, the method being as follows:

(1) batchwise introduction of a solution of initiator comprising:

8 parts of water; and

0.984 part of ammonium persulphate;

(2) feed during one hour and thirty minutes of a solution of initiator comprising:

28 parts of water; and

3.936 parts of ammonium persulphate.

After one hour and thirty minutes of feed, the reaction is allowed to continue for a further half hour. The reactor is cooled to 20° C. and a polymer is obtained which is soluble in water and has the composition:

| COMPOSITION | MAPEG 12 | MAM | AMPS |
|---|---|---|---|
| by weight | 46.30 | 11.74 | 41.96 |
| molar | 18.20 | 30 | 51.80 |

This polymer is water-soluble and forms a translucent solution. It has a precipitation temperature comparable with an LCST of 90° C.

### EXAMPLE 36

### Synthesis of a MAPEG 8/MAM/AMPS Copolymer

A mixture consisting of:

444 parts of water;

90.99 parts of AMPS;

88.77 parties de MAPEG 8; and

21.13 parties de MAM;

is introduced, with stirring (150 rpm; anchor stirrer), into a 1 litre reactor, and the reactor is brought to a temperature of 80° C. with nitrogen flushing. When the temperature of the reaction medium is stable at 80° C., a first solution of initiator is introduced batchwise, and another solution of initiator is introduced via continuous feed during one hour and thirty minutes, the method being as follows:

(1) batchwise introduction of a solution of initiator comprising:

8 parts of water; and

0.984 part of ammonium persulphate;

(2) feed during one hour and thirty minutes of a solution of initiator comprising:

28 parts of water; and

3.936 parts of ammonium persulphate.

After one hour and thirty minutes of feed, the reaction is allowed to continue for a further half hour. The reactor is cooled to 20° C. and a polymer is obtained which is soluble in water and has the composition:

| COMPOSITION | MAPEG 8 | MAM | AMPS |
|---|---|---|---|
| by weight | 43.94 | 10.57 | 45.49 |
| molar | 23 | 25 | 52 |

This polymer is water-soluble and forms a translucent solution. It has a precipitation temperature comparable with an LCST of from 37 to 38° C.

### EXAMPLE 37

### Synthesis of a MAPEG 8/MAM/AMPS (0.5% of Mercaptoethanol by Weight, Based on the Monomers)

A mixture consisting of:

444 parts of water;

90.99 parts of AMPS;

88.77 parts of MAPEG 8;

21.23 parts of MAM; and

1.02 parts of mercaptoethanol;

is introduced, with stirring (150 rpm; anchor stirrer), into a 1 litre reactor, and the reactor is brought to a temperature of 80° C. with nitrogen flushing. When the temperature of the reaction medium is stable at 80° C., a first solution of initiator is introduced batchwise, and another solution of initiator is introduced via continuous feed during one hour and thirty minutes, the method being as follows:

(1) batchwise introduction of a solution of initiator comprising:

8 parts of water; and

0.984 part of ammonium persulphate;

(2) feed during one hour and thirty minutes of a solution of initiator comprising:

28 parts of water; and

3.936 parts of ammonium persulphate.

After one hour and thirty minutes of feed, the reaction is allowed to continue for a further half hour. The reactor is cooled to 20° C. and a polymer is obtained which is soluble in water and has the composition:

| COMPOSITION | MAPEG 8 | MAM | AMPS |
|---|---|---|---|
| by weight | 43.94 | 10.57 | 45.49 |
| molar | 23 | 25 | 52 |

This polymer is water-soluble and forms a translucent solution. It has a precipitation temperature comparable with an LCST of 54° C.

### EXAMPLE 38

### Synthesis of a MAPEG 8/MAM/AMPS Copolymer (1.4% of Mercaptoethanol by Weight, Based on the Monomers)

A mixture consisting of:

444 parts of water;

90.99 parts of AMPS;

88.77 parts of MAPEG 8;

21.13 parts of MAM; and

2.86 parts of mercaptoethanol;

is introduced, with stirring (150 rpm; anchor stirrer), into a 1 litre reactor, and the reactor is brought to a temperature of 80° C. with nitrogen flushing. When the temperature of the reaction medium is stable at 80° C., a first solution of initiator is introduced batchwise, and another solution of initiator is introduced via continuous feed during one hour and thirty minutes, the method being as follows:

(1) batchwise introduction of a solution of initiator comprising:

8 parts of water; and

0.984 part of ammonium persulphate;

(2) feed during one hour and thirty minutes of a solution of initiator comprising:

28 parts of water; and

3.936 parts of ammonium persulphate.

After one hour and thirty minutes of feed, the reaction is allowed to continue for a further half hour. The reactor is cooled to 20° C. and a polymer is obtained which is soluble in water and has the composition:

| COMPOSITION | MAPEG 8 | MAM | AMPS |
|---|---|---|---|
| by weight | 43.94 | 10.57 | 45.49 |
| molar | 23 | 25 | 52 |

This polymer is water-soluble and forms an translucent solution. It has a precipitation temperature comparable with an LCST of 77° C.

The reduction in molar masses (increase in proportion of transfer agent) brings about an increase in the precipitation temperature.

### EXAMPLE 39

### Synthesis of a MAPEG 12/MAM/AMPS Copolymer (Synthesis at 80° C.)

A mixture consisting of:

444 parts of water;

83.93 parts of AMPS;

93.53 parts of MAPEG 12; and

23.48 parts of MAM;

is introduced, with stirring (150 rpm; anchor stirrer), into a 1 litre reactor, and the reactor is brought to a temperature of 80° C. with nitrogen flushing. When the temperature of the reaction medium is stable at 80° C., a first solution of initiator is introduced batchwise, and another solution of initiator is introduced via continuous feed during one hour and thirty minutes, the method being as follows.

(1) batchwise introduction of a solution of initiator comprising:

8 parts of water; and

0.984 part of ammonium persulphate;

(2) feed during one hour and thirty minutes of a solution of initiator comprising:

28 parts of water; and

3.936 parts of ammonium persulphate.

After one hour and thirty minutes of feed, the reaction is allowed to continue for a further half hour. The reactor is cooled to 20° C. and a polymer is obtained which is soluble in water and has the composition:

| COMPOSITION | MAPEG 12 | MAM | AMPS |
|---|---|---|---|
| by weight | 46.30 | 11.74 | 41.96 |
| molar | 18.20 | 30 | 51.80 |

This polymer is water-soluble and forms a translucent solution which is pale yellow in colour and relatively viscous. It has a precipitation temperature comparable with an LCST of 50° C.

### EXAMPLE 40

### Synthesis of a MAPEG 12/MAM/AMPS Copolymer (Synthesis at 65° C.)

A mixture consisting of:

444 parts of water;

83.93 parts of AMPS;

93.53 parts of MAPEG 12; and

23.48 parts of MAM;

is introduced, with stirring (150 rpm; anchor stirrer), into a 1 litre reactor, and the reactor is brought to a temperature of 65° C. with nitrogen flushing. When the temperature of the reaction medium is stable at 65° C., a first solution of initiator is introduced batchwise, and another solution of initiator is introduced via continuous feed during one hour and thirty minutes, the method being as follows:

(1) batchwise introduction of a solution of initiator comprising:

8 parts of water;

0.984 part of ammonium persulphate; and

0.20 part of sodium disulphite;

(2) feed during one hour and thirty minutes of a solution of initiator comprising:

28 parts of water; and

3.936 parts of ammonium persulphate.

After one hour and thirty minutes of feed, the reaction is allowed to continue for a further half hour. The reactor is cooled to 20° C. and a polymer is obtained which is soluble in water and has the composition:

| COMPOSITION | MAPEG 12 | MAM | AMPS |
|---|---|---|---|
| by weight | 46.30 | 11.74 | 41.96 |
| molar | 18.20 | 30 | 51.80 |

This polymer is water-soluble and forms a translucent solution. It has a precipitation temperature comparable with an LCST of 50° C.

### EXAMPLE 41

### Synthesis of a MAPEG 12/MAM/AMPS Copolymer (Synthesis at 71° C.)

A mixture consisting of:

444 parts of water;

83.93 parts of AMPS;

93.53 parts of MAPEG 12; and

23.48 parts of MAM;

is introduced, with stirring (150 rpm; anchor stirrer), into a 1 litre reactor, and the reactor is brought to a temperature of 71° C. with nitrogen flushing. When the temperature of the reaction medium is stable at 71° C., a first solution of initiator is introduced batchwise, and another solution of initiator is introduced via continuous feed during one hour and thirty minutes, the method being as follows:

(1) batchwise introduction of a solution of initiator comprising:

8 parts of water; and

0.984 part of ammonium persulphate;

(2) feed during one hour and thirty minutes of a solution of initiator comprising:

28 parts of water; and

3.936 parts of ammonium persulphate.

After one hour and thirty minutes of feed, the reaction is allowed to continue for a further half hour. The reactor is cooled to 20° C. and a polymer is obtained which is soluble in water and has the composition:

| COMPOSITION | MAPEG 12 | MAM | AMPS |
|---|---|---|---|
| by weight | 46.30 | 11.74 | 41.96 |
| molar | 18.20 | 30 | 51.80 |

This polymer is water-soluble and forms a translucent solution. It has a precipitation temperature comparable with an LCST of 50° C.

### EXAMPLE 42

### Synthesis of a MAPEG 12/MAM/AMPS Copolymer

A mixture consisting of:

444 parts of water;

83.93 parts of AMPS;

93.53 parts of MAPEG 12; and

23.48 parts of MAM;

is introduced, with stirring (150 rpm; anchor stirrer), into a 1 litre reactor, and the reactor is brought to a temperature of 80° C. with nitrogen flushing. When the temperature of the reaction medium is stable at 80° C., a first solution of initiator is introduced batchwise, and another solution of initiator is introduced via continuous feed during one hour and thirty minutes, the method being as follows:

(1) batchwise introduction of a solution of initiator comprising:

8 parts of water; and

0.984 part of ammonium persulphate;

(2) feed during one hour and thirty minutes of a solution of initiator comprising:

28 parts of water; and

3.936 parts of ammonium persulphate.

After one hour and thirty minutes of feed, the reaction is allowed to continue for a further half hour. The reactor is cooled to 20° C. and a polymer is obtained which is soluble in water and has the composition:

| COMPOSITION | MAPEG 12 | MAM | AMPS |
|---|---|---|---|
| by weight | 46.30 | 11.74 | 41.96 |
| molar | 18.20 | 30 | 51.80 |

This polymer is water-soluble and forms a translucent solution. It has a precipitation temperature comparable with an LCST of 50° C.

### EXAMPLE 43

### Synthesis of A MAPEG 8/MAM/AMPS Copolymer

A mixture consisting of:

444 parts of water;

97.71 parts of AMPS;

75.52 parts of MAPEG 8; and

27.34 parts of MAM;

is introduced, with stirring (150 rpm; anchor stirrer), into a 1 litre reactor, and the reactor is brought to a temperature of 80° C. with nitrogen flushing. When the temperature of the reaction medium is stable at 80° C., a first solution of initiator is introduced batchwise, and another solution of initiator is introduced via continuous feed during one hour and thirty minutes, the method being as follows:

(1) batchwise introduction of a solution of initiator comprising:

8 parts of water; and

0.984 part of ammonium persulphate;

(2) feed during one hour and thirty minutes of a solution of initiator comprising:

28 parts of water; and

3.936 parts of ammonium persulphate.

After one hour and thirty minutes of feed, the reaction is allowed to continue for a further half hour. The reactor is cooled to 20° C. and a polymer is obtained which is soluble in water and has the composition:

| COMPOSITION | MAPEG 8 | MAM | AMPS |
|---|---|---|---|
| by weight | 48.85 | 13.67 | 37.48 |
| molar | 18.20 | 30 | 51.80 |

This polymer is water-soluble and forms a translucent solution. It undergoes a change of appearance (precipitation) comparable with an LCST at a temperature of 20° C.

### EXAMPLE 44 (COMPARATIVE)

### Synthesis of a MAPEG 22/MAM/AMPS Copolymer

A mixture consisting of:

321 parts of water;

63.90 parts of AMPS;

242.258 parts of MAPEG 22 (48.80% of active material); and

23.48 parts of MAM;

is introduced, with stirring (150 rpm; anchor stirrer), into a 1 litre reactor, and the reactor is brought to a temperature of 80° C. with nitrogen flushing. When the temperature of the reaction medium is stable at 80° C., a first solution of initiator is introduced batchwise, and another solution of initiator is introduced via continuous feed during one hour and thirty minutes, the method being as follows:

(1) batchwise introduction of a solution of initiator comprising:

8 parts of water; and

0.984 part of ammonium persulphate;

(2) feed during one hour and thirty minutes of a solution of initiator comprising:

28 parts of water; and

3.936 parts of ammonium persulphate.

The viscosity of the reaction medium increases very rapidly. After twenty minutes the synthesis is terminated; the product forms a gel.

### EXAMPLE 45

### Synthesis of a MAPEG 12/MAM/AMPS Copolymer (Batch Process at 80° C.)

A mixture consisting of:

444 parts of water;

83.93 parts of AMPS;

93.53 parts of MAPEG 12; and

23.48 parts of MAM;

is introduced, with stirring (150 rpm; anchor stirrer), into a 1 litre reactor, and the reactor is brought to a temperature of 80° C. with nitrogen flushing. When the temperature of the reaction medium is stable at 80° C., a first solution of initiator is introduced batchwise, and another solution of initiator is introduced via continuous feed during one hour and thirty minutes, the method being as follows:

(1) batchwise introduction of a solution of initiator comprising:

8 parts of water; and

0.984 part of ammonium persulphate;

(2) feed during one hour and thirty minutes of a solution of initiator comprising:

28 parts of water; and

3.936 parts of ammonium persulphate.

After one hour and thirty minutes of feed, the reaction is allowed to continue for a further half hour. The reactor is cooled to 20° C. and a polymer is obtained which is soluble in water and has the composition:

| COMPOSITION | MAPEG 12 | MAM | AMPS |
|---|---|---|---|
| by weight | 46.30 | 11.74 | 41.96 |
| molar | 18.20 | 30 | 51.80 |

This polymer is water-soluble and forms a translucent solution. It has a precipitation temperature comparable with an LCST of 50° C.

### EXAMPLE 46 (COMPARATIVE)

### Synthesis of a MAPEG 12/MAM/AMPS Copolymer (Semicontinuous Process at 80° C.)

345 parts of water are introduced with stirring (150 rpm; anchor stirrer) into a 1 litre reactor and the reactor is brought to a temperature of 80° C. with nitrogen flushing. When the temperature of the water is stable at 80° C., a solution of initiator and a solution of monomers are fed separately and simultaneously, the method being as follows:

(1) feed during three hours of a solution of monomers comprising:

83.93 parts of AMPS;

93.53 parts of MAPEG 12; and

23.48 parts of MAM; and

100 parts of water;

(2) feed during four hours of a solution of initiator comprising:

35 parts of water; and

4.92 parts of ammonium persulphate.

After four hours of feed, the reaction is allowed to continue for a further one hour. The reactor is cooled to 20° C. and a polymer is obtained which is soluble in water and has the composition:

| COMPOSITION | MAPEG 12 | MAM | AMPS |
|---|---|---|---|
| by weight | 46.30 | 11.74 | 41.96 |
| molar | 18.20 | 30 | 51.80 |

This polymer is water-soluble and forms a translucent solution. It does not have a precipitation temperature comparable with an LCST.

### EXAMPLE 47

### Synthesis of a MAPEG 12/MAM/AMPS Copolymer (Semicontinuous Process at 65° C.)

345 parts of water are introduced with stirring (150 rpm; anchor stirrer) into a 1 litre reactor and the reactor is brought to a temperature of 65° C. with nitrogen flushing. When the temperature of the water is stable at 65° C., a solution of initiator and a solution of monomers are fed separately and simultaneously, the method being as follows:

(1) feed during four hours of a solution of monomers comprising:

83.93 parts of AMPS;

93.53 parts of MAPEG 12; and

23.48 parts of MAM; and

100 parts of water;

(2) feed during five hours of a solution of initiator comprising:

35 parts of water; and

4.92 parts of ammonium persulphate.

After five hours of feed, the reaction is allowed to continue for a further one hour. The reactor is cooled to 20° C. and a polymer is obtained which is soluble in water and has the composition:

| COMPOSITION | MAPEG 12 | MAM | AMPS |
|---|---|---|---|
| by weight | 46.30 | 11.74 | 41.96 |
| molar | 18.20 | 30 | 51.80 |

This polymer is water-soluble and forms a translucent solution. It has a precipitation temperature comparable with an LCST of 64° C.

### EXAMPLE 48

### Synthesis of a MAPEG 8/MAM/AMPS Copolymer (Batch Process at 80° C.)

A mixture consisting of:

444 parts of water;

90.99 parts of AMPS;

88.77 parts of MAPEG 8; and

21.13 parts of MAM;

is introduced, with stirring (150 rpm; anchor stirrer), into a 1 litre reactor, and the reactor is brought to a temperature of 80° C. with nitrogen flushing. When the temperature of the reaction medium is stable at 80° C., a first solution of initiator is introduced batchwise, and another solution of initiator is introduced via continuous feed during one hour and thirty minutes, the method being as follows:

(1) batchwise introduction of a solution of initiator comprising:

8 parts of water; and

0.984 part of ammonium persulphate;

(2) feed during one hour and thirty minutes of a solution of initiator comprising:

28 parts of water; and

3.936 parts of ammonium persulphate.

After one hour and thirty minutes of feed, the reaction is allowed to continue for a further half hour. The reactor is cooled to 20° C. and a polymer is obtained which is soluble in water and has the composition:

| COMPOSITION | MAPEG 8 | MAM | AMPS |
|---|---|---|---|
| by weight | 43.94 | 10.57 | 45.49 |
| molar | 23 | 25 | 52 |

This polymer is water-soluble and forms a translucent solution. It has a precipitation temperature comparable with an LCST of from 37 to 38° C.

### EXAMPLE 49

### Synthesis of a MAPEG 8/MAM/AMPS Copolymer (Semicontinuous Process at 80° C.)

345 parts of water are introduced with stirring (150 rpm; anchor stirrer) into a 1 litre reactor and the reactor is brought to a temperature of 80° C. with nitrogen flushing. When the temperature of the water is stable at 80° C., a solution of initiator and a solution of monomers are fed separately and simultaneously using the following method:

(1) feed during three hours of a solution comprising:

90.99 parts of AMPS;

88.77 parts of MAPEG 12; and

21.13 parties de MAM; and

100 parts of water;

(2) feed during four hours of a solution of initiator comprising:

35 parts of water; and

4.92 parts of ammonium persulphate.

After four hours of feed, the reaction is allowed to continue for a further one hour. The reactor is cooled to 20° C. and a polymer is obtained which is soluble in water and has the composition:

| COMPOSITION | MAPEG 8 | MAM | AMPS |
|---|---|---|---|
| by weight | 43.94 | 10.57 | 45.49 |
| molar | 23 | 25 | 52 |

This polymer is water-soluble and forms a translucent solution. It has a precipitation temperature comparable with an LCST of 75° C.

### EXAMPLE 50

### Synthesis of a MAPEG 8/MAM/AMPS Copolymer (Semicontinuous Process at 65° C.)

345 parts of water are introduced with stirring (150 rpm; anchor stirrer) into a 1 litre reactor, and the reactor is brought to a temperature of 65° C. with nitrogen flushing. When the temperature of the water is stable at 65° C., a solution of initiator and a solution of monomers are fed separately and simultaneously, the method being as follows:

(1) feed during four hours of a solution comprising:

90.99 parts of AMPS;

88.77 parts of MAPEG 8; and

21.13 parts of MAM; and

100 parts of water;

(2) feed during five hours of a solution of initiator comprising:

35 parts of water; and

4.92 parts of ammonium persulphate.

After five hours of feed, the reaction is allowed to continue for a further one hour. The reactor is cooled to 20° C. and a polymer is obtained which is soluble in water and has the composition:

| COMPOSITION | MAPEG 8 | MAM | AMPS |
|---|---|---|---|
| by weight | 43.94 | 10.57 | 45.49 |
| molar | 23 | 25 | 52 |

This polymer is water-soluble and takes the form of forms translucent solution. It has a precipitation temperature comparable with an LCST of 57° C.

1. Heat-sensitive water-soluble copolymer characterized in that it is obtained from a composition of monomers comprising, for 100 molar parts:
(A) from 10 to 69 molar parts of at least one water-soluble compound chosen from those of the formulae (I) and (II) below: 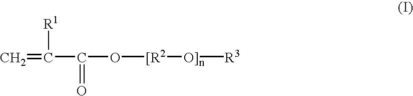
where:
R¹ represents H or —CH₃;
R³ represents a C₂ alkylene radical which optionally contains one or more OH groups, or a C₃-C₄ alkylene radical which contains one or more OH groups;
R³ represents H or —CH₃; and
n is a whole number between 1 and 70; 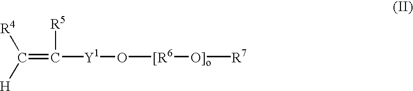
where:
each of R⁴ and R⁵ independently represents hydrogen or C₂-C₄ alkyl;
Y² is a single bond or a C₁-C₄ alkylene radical;
R⁶ represents a C₂ alkylene radical which optionally contains one or more OH groups, or a C₃-C₄ alkylene radical which contains one or more OH groups;
R⁷ represents H or —CH₃; and
o is a whole number between 1 and 70;
(B) from 30 to 75 molar parts of an least one water-soluble monomer chosen from the ethylenically unsaturated sulphonic acids;
(C) from 0 to 50 molar parts of at least one water-soluble compounds selected from those of the formulae (III) and (IV): 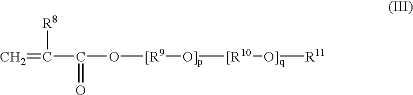
where:
R⁸ represents H or —CH₃;
each of R⁹ and R¹⁰ independently represents a C₂-C₄ alkylene radical which optionally contains one or more OH groups, where each of R⁹ and R¹⁰ differs from the other;
R¹¹ represents H or —CH₃;
p is a whole number between 1 and 70; and
q is a whole number between 1 and 40; 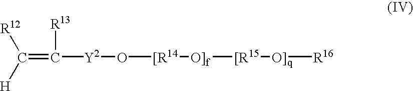
where:
each of R¹² and R¹³ independently represents hydrogen or C₂-C₄ alkyl;
Y² is a single bond or a C₁-C₄ alkylene radical;
each of R¹⁴ and R¹⁵ independently represents a C₂-C₄ alkylene radical optionally containing one or more OH groups, where each of R¹⁴ and R¹⁵ differs from the other;
R¹⁶ represents H or —CH₃;
r is a whole number between 1 and 70; and
s is a whole number between 1 and 40;
(D) from 0 to 30 molar parts of at least one water-soluble compound chosen from those of formulae (V) and (VI): 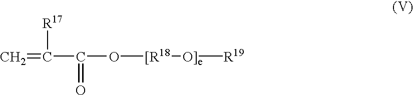
where:
R¹⁷ represents H or —CH₃;
R¹⁸ represents a C₃-C₄ alkylene radical which optionally contains one or more OH groups;
R¹⁹ represents a C₂-C₄₀ alkyl chain, or a C₆-C₆₀ aralkyl or aryl chain; and
t is a whole number between 1 and 70; 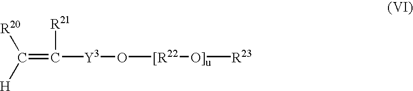
where:
each of R²⁰ and R²¹ independently represents hydrogen or C₂-C₄ alkyl;
Y³ is a single bond or a C₁-C₄ alkylene radical;
R²² represents a C₂-C₄ alkylene radical which optionally contains one or more OH groups;
R³³ is a C₂-C₄₀ alkyl radical or a C₆-C₆₀ aralkyl or aryl radical; and
u is a whole number between 1 and 70;
(E) from 0 to 30 molar parts of at least one water-soluble monomer chosen from:
(E1) water-soluble compounds of formula (VII): 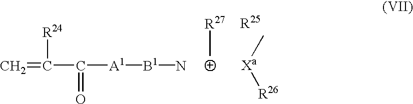
where:
R²⁴ represents H or —CH₃;
A¹ represents —O— or —NH—;
B¹ represents —CH₂CH₂—, —CH₂CH₂CH₂— or —CH₂CHOHCH₂—;
each of R²⁵ and R²⁶ independently represents —CH₃ or a C₂-C₁₆ alkyl chain;
R³⁷ represents H, —CH₃ or a C₂-C₁₆ alkyl chain;
X^{a} represents a monovalent anion, such as Cl^{a}, SCN^{a}, CH₃SO₃^{a} or Br^{a};
(E2) water-soluble compounds of formula (VIII): 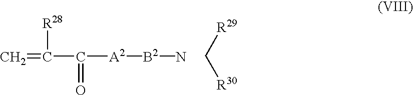
where:
A² represents —O— or —NH—;
B² represents —CH₂CH₂—, —CH₂CH₂CH₂— or —CH₂CHOHCH₂—;
R²⁸ represents H or —CH₃; and
each of R²⁹ and R³⁰ independently represents —CH, or a C₂-C₁₆ alkyl chain;
(E3) water-soluble monomers chosen from the ethylenically unsaturated carboxylic acids and their salts and the anhydrides of ethylenically unsaturated carboxylic acids;
(E4) water-soluble ethylenically unsaturated silane monomers;
(E5) water-soluble ethylenically unsaturated phosphate-function monomers;
(E6) water-soluble ethylenically unsaturated phosphonate monomers and their salts;
(E7) water-soluble monomers having N-vinyl groups;
(E8) water-soluble compounds of formula (IX): 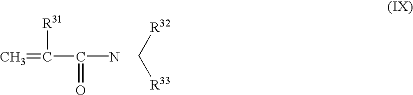
where:
R³¹ represents H or —CH;
R³² and R³³ are identical or different, each independently representing H, C₁-C₅ alkyl which optionally contains one or more OH groups, or (C₁-C₅ alkoxy)-C₁-C₅ alkyl;
(E9) acrylonitrile;
(E10) allyl alcohol;
(E11) vinylpyridine;
(E12) N-(meth)acryloyltris(hydroxymethyl)-methylamine; and
(E13) 2-(acetoacetoxy)ethyl (meth)acrylate; and
(F) from 0.001 to 50 molar parts of at least one hydrophobic monomer,
the said heat-sensitive water-soluble copolymer having an LCST of from 6° C. to 95° C.

2. Heat-sensitive water-soluble copolymer according to claim 1, characterized in that the monomer(s) (A) of formula (I) are chosen from the compounds of formula (Ia): 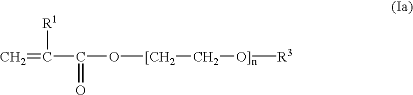
where R¹, R³ and n are as defined in claim 1.

3. Heat-sensitive water-soluble copolymer according to claim 1 or 2, characterized in that the monomer(s) (A) of formula (II) are chosen from the compounds of formula (IIa) or (IIb)): 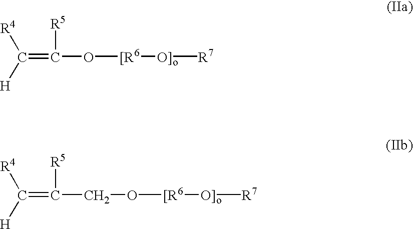
where R⁴ to R⁷ and o are as defined in claim 1.

4. Heat-sensitive water-soluble copolymer according to any of claims 1 to 3, characterized in that the monomer (B) is 2-acrylamido-2-methylpropanesulphonic acid.

5. Heat-sensitive water-soluble copolymer according to any of claims 1 to 4, characterized in that the preferred monomer(s) (C) of formula (III) are in particular chosen from the compounds of formula (IIIa) or (IIIb): 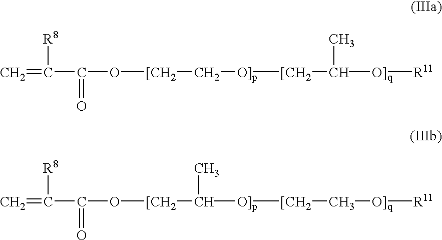
where R⁸, R¹¹, p and q are as defined in claim 1.

6. Heat-sensitive water-soluble copolymer according to any of claim 1 to 5, characterized in that the compound(s) (E1) of formula (VII) are chosen from the (meth)acryloyloxyethyltrimethylammonium halides.

7. Heat-sensitive water-soluble copolymer according to any of claims 1 to 6, characterized in that the compound(s) (E2) of formula (VIII) are chosen from dimethylaminoethyl acrylate and dimethylaminoethyl methacrylate.

8. Heat-sensitive water-soluble copolymer according to any of claims 1 to 7, characterized in that the compound(s) (E3) are chosen from methacrylic acid and its salts.

9. Heat-sensitive water-soluble copolymer according to any of claims 1 to 8, characterized in that the compound(s) (E4) are chosen from the (meth)acryloxyalkylsilanes.

10. Heat-sensitive water-soluble copolymer according to any of claims 1 to 9, characterized in that the monomer(s) (E6) are chosen from allylphosphonic acid and its salts.

11. Heat-sensitive water-soluble copolymer according to any of claims 1 to 10, characterized in that the compound(s) (E7) are in particular chosen from N-vinylacetamide, N-vinylpyrrolidone, N-vinylimidazole and N-vinylcaprolactam.

12. Heat-sensitive water-soluble copolymer according to any of claims 1 to 10, characterized in that the compound(s) (E8) are chosen from acrylamide, methacrylamide, N-isopropylacrylamide, N-ethoxypropylacrylamide, N-methylol (meth)acrylamide, N,N-dimethylacrylamide, and N-(2-hydroxypropyl) (meth)acrylamide.

13. Heat-sensitive water-soluble copolymer according to any of claims 1 to 12, characterized in that the compound(s) (F) are chosen from:
(F1) the monomers of formula (X): 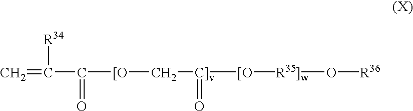
where:
R³⁴ represents H or —CH₃;
v is 0 or 1;
R³⁵ represents a C₁-C₆ alkylene radical;
w is 0 or is a whole number between 1 and 10; and
R³⁶ represents a C₁-C₃₂ alkyl radical or a cycloalkyl radical;
(F2) the monomers of formula (X): 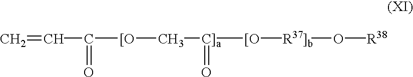
where:
a is 0 or 1;
R³⁷ represents a C₁-C₆ alkylene radical or a halogenated C₁-C₆ alkylene radical;
b is 0 or is a whole number between 1 and 10;
R³⁸ represents a C₁-C₂₀ alkyl radical, a cycloalkyl radical, a halogenated alkyl radical or a halogenated cycloalkyl radical,
with the proviso that if b is 0 R³⁸ is a halogenated C₁-C₁₆ alkyl radical or a halogenated cycloalkyl radical;
(F3) the hydrophobic vinyl monomers of formula (XII):
CH₂═CH—R¹⁹
where R³⁹ is an alkyl carboxylate group or alkyl ether group containing from 1 to 18 carbon atoms, an aryl or aralkyl group or a cycloalkyl group;
(F4) the monomers of formula (XIII): 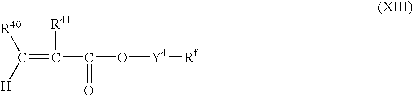
where:
one of R⁴⁰ and R⁴¹ represents a hydrogen atom and the other represents a hydrogen atom or an alkyl radical containing from 1 to 4 carbon atoms;
Y⁴ represents a bivalent hydrocarbon chain bonded to O by a carbon atom and may contain one or more heteroatoms chosen from oxygen, sulphur and nitrogen; and
R^{f} represents a perfluorinated straight-chain or branched radical containing from 2 to 20 carbon atoms, preferably from 4 to 16 carbon atoms;
(F5) monomers chosen from vinyl chloride and fluoride and vinylidene chloride and fluoride;
(F6) the hydrophobic monomers of formula (XIV): 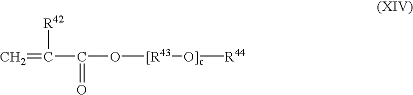
where:
R⁴² represents H or —CH₃;
R⁴³ represents a C₃-C₄ alkylene radical;
c is a whole number between 1 and 70; and
R⁴⁴ represents H or —CH₃;
(F7) the hydrophobic monomers of formula (XV): 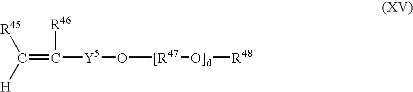
where:
each of R⁴⁵ and R⁴⁶ independently represents hydrogen or C₂-C₄ alkyl;
Y⁵ is a single bond or a C₁-C₄ alkylene radical;
R⁴⁷ represents a C₃-C₄ alkylene radical;
d is a whole number between 1 and 70; and
R⁴⁸ represents H or —CH₃;
(F8) the fluorostyrenes;
(F9) the compounds of formula (XVI): 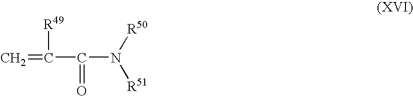
where:
R⁴⁹ represents H or —CH₃;
R⁵⁰ and R⁵¹ are identical or different, each independently representing a C₆-C₂₄ alkyl radical or a cycloalkyl radical; and
(F10) the n-alkyltriethoxysilane compounds and the n-alkyl-trimethoxysilane compounds having C₆-C₁₈ alkyl groups.

14. Heat-sensitive water-soluble copolymer according to claim 13, characterized in that the compounds of formula (XIV) are chosen from those containing an R⁴³ which is a 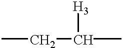
radical or —CH₂—CH₂—CH₃—CH₂ radical.

15. Heat-sensitive water-soluble copolymer according to claim 13 or 14, characterized in that the compounds of formula (XV) are chosen from those having an R⁴⁷ which is a 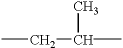
or —CH₂—CH₂—CH₂—CH₂ and a Y⁶ which is a single bond or —CH₂—.

16. Heat-sensitive water-soluble copolymer according to any of claims 13 to 15, characterized in that the compounds of formula (XVI) are chosen from N-(tert-butyl)(meth)acrylamide, N-decyl(meth)acrylamide, N-dodecyl-(meth)acrylamide and N-(n-octadecyl)(meth)acrylamide.

17. Heat-sensitive water-soluble copolymer according to any of claims 13 to 16, characterized in that the compound (F10) is n-octadecyltriethoxysilane

18. Heat-sensitive water-soluble copolymer according to any of claims 1 to 17, characterized in that it has been obtained from a composition of monomers which is as defined in any of claims 1 to 12 and in which at least one chain-transfer agent has been incorporated.

19. Heat-sensitive water-soluble copolymer according to any of claims 1 to 18, characterized in that the chain-transfer agent(s) is/are chosen from mercaptoethanol, isopropanol, the alkyl mercaptans, carbon tetrachloride and triphenylmethane.

20. Heat-sensitive water-soluble copolymer according to claim 18 or 19, characterized in that the chain-transfer agent(s) has/have been used at the rate of from 0.05 to 8% by weight, based on the total weight of the monomers.

21. Heat-sensitive water-soluble copolymer according to any of claims 1 to 20, characterized in that it has an LCST of from 20 co 35° C.

22. Heat-sensitive water-soluble copolymer according to any of claims 1 to 21, characterized in that it forms an aqueous solution.

23. Process for manufacturing any copolymer as defined in any of claims 1 to 22, characterized in that the free-radical polymerization of monomers as defined in any of claims 1 to 22 is conducted in an organic or aqueous solvent medium or in an organic solvent/water mixture.

24. Process according to claim 23, characterized in that the polymerization is carried out with a total concentration of monomers of between 5 and 75% by weight, in particular from 15 to 50% by weight.

25. Process according to claim 23 or 24, characterized in that the copolymerization is carried out in the presence of at least one initiator which is a free-radical generator, in particular chosen from the persulphates, the peroxides and the diazo compounds, the rate of use of the initiator(s) being in particular from 0.1 to 5% by weight, particularly from 0.5 to 3% by weight, based on the total weight of the monomers involved.

26. Process according co claim 23 or 24, characterized in that the copolymerization is carried out with initiation by irradiation, for example in the presence of UV radiation and of photoinitiators such as benzophenone, 2-methylanthraquinone and 2-chlorothioxanthone.

27. Process according to any of claims 23 to 26, characterized in that the copolymerization is carried out in the presence of at least one chain-transfer agent, in particular used at a rate of from 0.05 to 8% by weight, based on the total weight of the monomers, and in particular chosen from mercaptoethanol, isopropanol, the alkyl mercaptans, carbon tetrachloride and triphenylmethane.

28. Process according to any of claims 23 to 27, characterized in that the copolymerization is carried out at a temperature of from −40° C. to 200° C., in particular from 50 to 95° C.

29. Process according to any of claims 23 to 28, characterized in that the LCST of the target copolymer is adjusted as a function of the composition of the monomers and/or of the amount of the chain-transfer agent used and/or of the temperature and/or of the batchwise or semicontinuous conduct of the process.

30. Mixture in an aqueous medium of at least one heat-sensitive water-soluble copolymer as defined in any of claims 1 to 22 or prepared by a process as defined in any of claims 23 to 29, with at least one hydrophobic (co)polymer.

31. use of a copolymer as defined in any of claims 1 to 22 or prepared by a process as defined in any of claims 23 to 29, or of a mixture as defined in claim 30 containing at most 50% by weight of hydrophobic (co)polymer(s) based on all of the polymers, for manufacturing water-dispersible films or water-disintegrable films, in particular being a constituent of water-disintegrable hygiene items.

32. Water-dispersible or water-disintegrable films obtained by drying a copolymer as defined in any of claims 1 to 22 or prepared by a process as defined in any of claims 23 to 29, or of a mixture as defined in claim 30 containing at most 50% by weight of hydrophobic (co)polymer, based on all of the copolymers.

33. use of a copolymer as defined in any of claims 1 to 32 or prepared by a process as defined in any of claims 23 to 29 as a binder or binder component for fibrous sheets or as a component of adhesives or as a component of a compounded polymer material, in particular as a constituent of water-disintegrable hygiene items.

34. hygiene items, particularly disposables, of which the copolymer as defined in any of claims 1 to 22 or prepared by a process as defined in any of claims 23 to 29, or a mixture as defined in claim 30 containing at most 50% by weight of hydrophobic (co)polymer, based on all of the copolymers, is a constituent, either being a water-soluble or water-disintegrable film, or being a binder used in the production of fibrous sheets which are incorporated into these items, or for the formulation of adhesives connecting the various constituents of the hygiene item, or as a component of the compounded polymer material forming the underwrap of the item.
